(19) United States
(12) Patent Application Publication
(10) Pub. No.: US 2013/0159005 A1
(43) Pub. Date: Jun. 20, 2013

(54) AUDIO DECODING DEVICE, AUDIO DECODING METHOD, AUDIO DECODING PROGRAM, AUDIO ENCODING DEVICE, AUDIO ENCODING METHOD, AND AUDIO ENCODING PROGRAM

(71) Applicant: NTT DOCOMO, Inc, Tokyo (JP)

(72) Inventors: Kei KIKUIRI, Tokyo (JP); Choong Seng BOON, Tokyo (JP)

(73) Assignee: NTT DOCOMO, INC, Tokyo (JP)

(21) Appl. No.: 13/765,109

(22) Filed: Feb. 12, 2013

Related U.S. Application Data
(63) Continuation of application No. PCT/JP2011/068388, filed on Aug. 11, 2011.

(30) Foreign Application Priority Data
Aug. 13, 2010 (JP) 2010-181345

(51) Int. Cl. G10L 19/00

(52) U.S. Cl. CPC G10L 19/00
USPC 704/500

(57) ABSTRACT

In an audio decoding device of an embodiment, a plurality of decoding units execute different audio decoding schemes, respectively, to generate audio signals from coded sequences. An extraction unit extracts long-term encoding scheme information from a stream. The stream has a plurality of frames each including a coded sequence of an audio signal. The long-term encoding scheme information is a unit information for multiple frames and indicates that a common audio encoding scheme was used to generate coded sequences of the multiple frames. According to the extracted long-term encoding scheme information, a selection unit selects, from the plurality of decoding units, a decoding unit to be used commonly to decode the coded sequences of the multiple frames.

### RELATED APPLICATIONS

This application is a continuation of PCT/JP2011/068388 filed on Aug. 11, 2011, which claims priority to Japanese Application No. 2010-181345 filed on Aug. 13, 2010. The entire contents of these applications are incorporated herein by reference

### TECHNICAL FIELD

A variety of aspects of the present invention relate to an audio decoding device, audio decoding method, audio decoding program, audio encoding device, audio encoding method, and audio encoding program.

### BACKGROUND ART

In order to efficiently encode both speech and music signals, a complex audio encoding system is found effective which is used to switch between an encoding scheme suitable for speech signal and an encoding scheme suitable for music signal.

Patent Literature 1 below describes such a complex audio encoding system. In the audio encoding system described in Patent Literature 1, each frame is added with information indicative of the type of an encoding scheme used for generation of a coded sequence for the frame.

The audio encoding in MPEG USAC (Unified Speech and Audio Coding) uses three encoding processes, i.e., FD (Modified AAC (Advanced Audio Coding)), TCX (transform coded excitation), and ACELP (Algebraic Code Excited Linear Prediction). In MPEG USAC, TCX and ACELP are collectively recognized as LPD. In MPEG USAC, each frame is added with 1-bit information to indicate whether FD or LPD was used. When LPD is used in MPEG USAC, each frame is added with 4-bit information to define a procedure of using a combination of TCX and ACELP.

Furthermore, AMR-WB+ (Extended Adaptive Multi-Rate Wideband) of Third Generation Partnership Project (3GPP) uses two encoding schemes, i.e., TCX and ACELP. In AMR-WB+, each frame is added with 2-bit information to discern use of TCX or ACELP.

### CITATION LIST

Patent Literature 1: Japanese Patent Application Laid-open No. 2000-267699

### SUMMARY OF THE INVENTION

### Technical Problem

There are audio signals in some cases which consist mainly of speech signals based on human voice, and there are audio signals in some other cases which consist mainly of music signals. In encoding such audio signals, a common encoding scheme is expected to be used for multiple frames. For such audio signals, there is demand for a technique to enable more efficient information transmission from the encoder side to the decoder side, for such audio signals.

It is an object of various aspects of the present invention to provide an audio encoding device, audio encoding method, and audio encoding program capable of generating a small-size stream and an audio decoding device, audio decoding method, and audio decoding program capable of using a small-size stream.

### Solution to Problem

An aspect of the present invention relates to audio encoding and may include an audio encoding device, audio encoding method, and audio encoding program described below:

An audio encoding device according to an aspect of the present invention comprises a plurality of encoding units, a selection unit, a generation unit, and an output unit. The plurality of encoding units each perform a different audio encoding scheme to generate a coded sequence from audio signals. The selection unit selects, from the plurality of encoding units, an encoding unit which may be used commonly to encode audio signals of multiple frames, or selects from the same a set of encoding units which may each be used commonly to encode audio signals of multiple super-frames including a plurality of frames. The generation unit generates long-term encoding scheme information. The long-term encoding scheme information is a unit of information for multiple frames and indicates that a common audio encoding scheme was used to generate coded sequences of the multiple frames. Alternatively, the long-term encoding scheme information is a unit of information for multiple super-frames and indicates that a set of common audio encoding schemes were used to generate coded sequences of the multiple super-frames. The output unit outputs a stream which includes the coded sequences of the multiple frames generated by the encoding unit selected by the selection unit, or the coded sequences of the multiple super-frames generated by the set of encoding units selected by the selection unit, and the long-term encoding scheme information.

An audio encoding method according to another aspect of the present invention comprises: (a) a step of selecting, from a plurality of audio encoding schemes each different from each other, an audio encoding scheme which may be used commonly to encode audio signals of multiple frames, or selecting from the same a set of audio encoding schemes which may each be used commonly to encode audio signals of multiple super-frames which include a plurality of frames; (b) a step of encoding the audio signals of the multiple frames with the selected audio encoding scheme to generate coded sequences of the multiple frames, or encoding the audio signals of the multiple super-frames with the selected set of audio encoding schemes to generate coded sequences of the multiple super-frames; (c) a step of generating a unit of long-term encoding scheme information for the multiple frames indicative of the common audio encoding scheme used to generate the coded sequences of the multiple frames, or a unit of long-term encoding scheme information for the multiple super-frames indicative of the set of common audio encoding processes used to generate the coded sequences of the multiple super-frames; and (d) a step of outputting a stream including the coded sequences of the multiple frames or the coded sequences of the multiple super-frames, and the long-term encoding scheme information.

An audio encoding program according to another aspect of the present invention causes a computer to function as a plurality of encoding units, a selection unit, a generation unit, and an output unit.

Since the audio encoding device, the audio encoding method, and the audio encoding program according to the aspects of the present invention employ long-term encoding scheme information, the encoder side can notify the common audio encoding scheme used to generate the coded sequences of the multiple frames or the set of common audio encoding schemes used to generate the coded sequences of the multiple super-frames. With the long-term encoding scheme information so notified, the decoder side can select a common audio decoding scheme or a common set of audio decoding schemes. Therefore, it is possible to reduce an amount of information included in the stream and used to specify the audio encoding scheme.

In an embodiment, the stream may be configured to include multiple frames in which each of the frames coming subsequent to the lead frame does not have to include information for specifying an audio encoding scheme used to generate a coded sequence of the subsequent frames.

In another embodiment, an encoding unit (or a predetermined audio encoding scheme) may be pre-selected for the multiple frames from the plurality of encoding units (or the plurality of audio encoding schemes), and the stream may include no information for specifying the audio encoding scheme used to generate the coded sequences of the multiple frames. This embodiment enables a further reduction in the information amount of the stream. In another embodiment, the long-term encoding scheme information may be 1-bit information. This embodiment enables a further reduction in the information amount of the stream.

Aspects of the present invention relate to audio decoding and may include an audio decoding device, audio decoding method, and audio decoding program.

An audio decoding device according to an aspect of the present invention comprises a plurality of decoding units, an extraction unit, and a selection unit. The plurality of decoding units each perform a different audio decoding scheme to generate audio signals from coded sequences. The extraction unit extracts long-term encoding scheme information from a stream. The stream has multiple frames each including a coded sequence of an audio signal and/or multiple super-frames each including a plurality of frames. The long-term encoding scheme information is a unit of long-term encoding scheme information for multiple frames and indicates that a common audio encoding scheme was used to generate coded sequences of the multiple frames, or the long-term encoding scheme information is a unit of long-term encoding scheme information for multiple super-frames and indicates that a set of common audio encoding schemes were used to generate coded sequences of the multiple super-frames. The selection unit selects, from the plurality of decoding units, a decoding unit to be used commonly to decode the coded sequences of the multiple frames in response to extraction of the long-term encoding scheme information. Alternatively, the selection unit selects, from the plurality of decoding units, a set of decoding units to be used commonly to decode the coded sequences of the multiple super-frames.

An audio decoding method according to another aspect of the present invention comprises: (a) a step of extracting, from a stream having multiple frames each including a coded sequence of an audio signal and/or multiple super-frames each including a plurality of frames, a single unit long-term encoding scheme information for the multiple frames which indicates a common audio encoding used to generate the coded sequences of the multiple frames, or a single unit long-term encoding scheme information for the multiple super-frames which indicates a set of common audio encoding schemes used to generate the coded sequences of the multiple super-frames; (b) in response to extraction of the long-term encoding scheme information, a step of selecting, from a plurality of different audio decoding schemes, an audio decoding scheme used commonly to decode the coded sequences of the multiple frames or selecting from the same a set of audio decoding schemes used commonly to decode the coded sequences of the multiple super-frames; and (c) a step of decoding the coded sequences of the multiple frames with the selected audio decoding scheme or decoding the coded sequences of the multiple super-frames with the set of selected audio decoding schemes.

An audio decoding program according to another aspect of the present invention causes a computer to function as the plurality of decoding units, the extraction unit and the selection unit.

The audio decoding device, audio decoding method, and audio decoding program according to another aspect of the present invention can generate the audio signals from the stream generated based on the aforementioned aspects of the present invention concerning encoding.

In an embodiment, the stream may be configured so that each of the frames coming subsequent to the lead frame in the plurality of frames does not include information for specifying an audio encoding scheme used to generate coded sequences of the subsequent frames.

In another embodiment, a decoding unit (or a predetermined audio decoding scheme) may be pre-selected form the multiple frames from the plurality of decoding units (or the plurality of audio decoding schemes), and the stream may include no information for specifying the audio encoding scheme used to generate the coded sequences of the multiple frames. This embodiment enables a further reduction in the amount of information in the stream. In another embodiment, the long-term encoding scheme information may be 1-bit information. This embodiment enables a further reduction in the amount of information in the stream.

### Advantageous Effect of Invention

As described above, the aspects of the present invention provide an audio encoding device, an audio encoding method, and an audio encoding program which generate a smaller size stream, and provide an audio decoding device, an audio decoding method, and an audio decoding program which use the smaller size stream.

### BRIEF DESCRIPTION OF THE DRAWINGS

FIG. 1 is a drawing showing an audio encoding device according to one embodiment.

FIG. 2 is a drawing showing a stream generated by the audio encoding device according to one embodiment.

FIG. 3 is a flowchart showing an audio encoding method according to one embodiment.

FIG. 4 is a drawing showing an audio encoding program according to one embodiment.

FIG. 5 is a drawing showing a hardware configuration of a computer according to one embodiment.

FIG. 6 is a perspective view showing a computer according to one embodiment.

FIG. 7 is a drawing showing an audio encoding device according to a modified embodiment.

FIG. 8 is a drawing showing an audio decoding device according to one embodiment.

FIG. 9 is a flowchart showing an audio decoding method according to one embodiment.

FIG. 10 is a drawing showing an audio decoding program according to one embodiment.

FIG. 11 is a drawing showing an audio encoding device according to another embodiment.

FIG. 12 is a drawing showing a stream generated according to the conventional MPEG USAC and a stream generated by the audio encoding device shown in FIG. 11.

FIG. 13 is a flowchart of an audio encoding method according to another embodiment.

FIG. 14 is a drawing showing an audio encoding program according to another embodiment.

FIG. 15 is a drawing showing an audio decoding device according to another embodiment.

FIG. 16 is a flowchart of an audio decoding method according to another embodiment.

FIG. 17 is a drawing showing a relation between mod[k] and a(mod[k]).

FIG. 18 is a drawing showing an audio decoding program according to another embodiment.

FIG. 19 is a drawing showing an audio encoding device according to another embodiment.

FIG. 20 is a drawing showing a stream generated according to the conventional AMR WB+ and a stream generated by the audio encoding device shown in FIG. 19.

FIG. 21 is a flowchart of an audio encoding method according to another embodiment.

FIG. 22 is a drawing showing an audio encoding program according to another embodiment.

FIG. 23 is a drawing showing an audio decoding device according to another embodiment.

FIG. 24 is a flowchart of an audio decoding method according to another embodiment.

FIG. 25 is a drawing showing an audio decoding program according to another embodiment.

FIG. 26 is a drawing showing an audio encoding device according to another embodiment.

FIG. 27 is a drawing showing a stream generated by the audio encoding device shown in FIG. 26.

FIG. 28 is a flowchart of an audio encoding method according to another embodiment.

FIG. 29 is a drawing showing an audio encoding program according to another embodiment.

FIG. 30 is a drawing showing an audio decoding device according to another embodiment.

FIG. 31 is a flowchart of an audio decoding method according to another embodiment.

FIG. 32 is a drawing showing an audio decoding program according to another embodiment.

FIG. 33 is a drawing showing an audio encoding device according to another embodiment.

FIG. 34 is a drawing showing a stream generated according to the conventional MPEG USAC and a stream generated by the audio encoding device shown in FIG. 33.

FIG. 35 is a flowchart of an audio encoding method according to another embodiment.

FIG. 36 is a drawing showing an audio encoding program according to another embodiment.

FIG. 37 is a drawing showing an audio decoding device according to another embodiment.

FIG. 38 is a flowchart of an audio decoding method according to another embodiment.

FIG. 39 is a drawing showing an audio decoding program according to another embodiment.

FIG. 40 is a drawing showing an audio encoding device according to another embodiment.

FIG. 41 is a drawing showing a stream generated by the audio encoding device shown in FIG. 40.

FIG. 42 is a flowchart of an audio encoding method according to another embodiment.

FIG. 43 is a drawing showing an audio encoding program according to another embodiment.

FIG. 44 is a drawing showing an audio decoding device according to another embodiment.

FIG. 45 is a flowchart of an audio decoding method according to another embodiment.

FIG. 46 is a drawing showing an audio decoding program according to another embodiment.

FIG. 47 is a drawing showing an audio encoding device according to another embodiment.

FIG. 48 is a drawing showing a stream generated according to the conventional AMR WB+ and a stream generated by the audio encoding device shown in FIG. 47.

FIG. 49 is a flowchart of an audio encoding method according to another embodiment.

FIG. 50 is a drawing showing an audio encoding program according to another embodiment.

FIG. 51 is a drawing showing an audio decoding device according to another embodiment.

FIG. 52 is a flowchart of an audio decoding method according to another embodiment.

FIG. 53 is a drawing showing an audio decoding program according to another embodiment.

### DETAILED DESCRIPTION OF THE PREFERRED EMBODIMENTS

Various embodiments will be described below in detail with reference to the drawings. Identical or equivalent portions will be denoted by the same reference signs throughout the drawings.

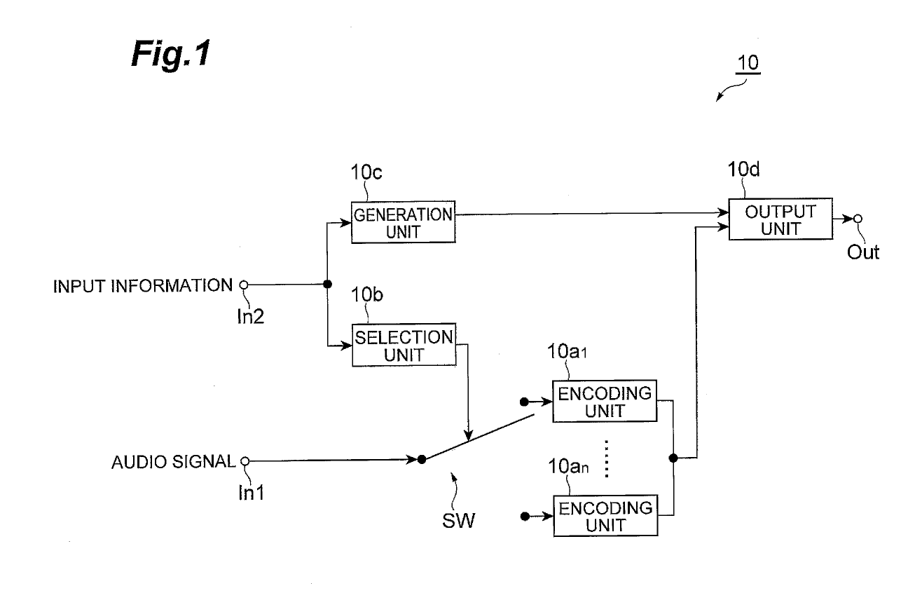

FIG. 1 is a drawing showing an audio encoding device according to an embodiment. The audio encoding device 10 shown in FIG. 1 is a device that encodes audio signals of multiple frames fed to an input terminal In1, using a common audio encoding scheme. As shown in FIG. 1, the audio encoding device 10 is formed with a plurality of encoding units 10a₁-10aₙ, a selection unit 10b, a generation unit 10c, and an output unit 10d. The number n herein is an integer not less than 2.

The encoding units 10a₁-10aₙ each perform a different audio encoding scheme to generate coded sequences from the audio signals. These audio encoding schemes to be adopted may be any audio encoding schemes. For example, the audio encoding schemes adoptable herein may include Modified AAC encoding scheme, ACELP encoding scheme, and TCX encoding scheme.

The selection unit 10b selects one encoding unit from the encoding units 10a₁-10aₙ according to input information fed to an input terminal In2. The input information is, for example, information entered by a user. In one embodiment, this input information may be information for specifying an audio encoding scheme used commonly for audio signals of multiple frames. The selection unit 10b controls a switch SW to selectively connect the input terminal In1 to an encoding unit of the encoding units 10a₁-10aₙ to perform an audio encoding scheme specified by the input information.

The generation unit 10c generates long-term encoding scheme information, based on the input information. The long-term encoding scheme information indicates an audio encoding scheme used commonly to generate coded sequences of the multiple frames. The long-term encoding scheme information may be a unique word identifiable by the decoder side. In one embodiment, it may be any information that enables the decoder side to identify an audio encoding scheme used commonly to generate coded sequences of the multiple frames.

The output unit 10d outputs a stream which includes the coded sequences of the multiple frames generated by the selected encoding unit and the long-term encoding scheme information generated by the generation unit 10c.

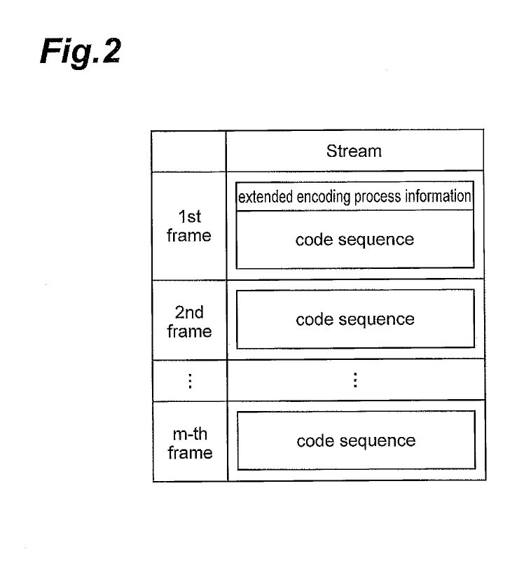

FIG. 2 is a drawing showing an exemplary stream generated by the audio encoding device according to one embodiment. The stream shown in FIG. 2 contains the first to the m-th frame. In this example, m is an integer not less than 2. In the description hereinafter, the frames in a stream will sometimes be referred to as output frames. Each output frame contains, as to an input audio signal, a coded sequence generated from the audio signal of a frame corresponding to the output frame. The first frame of the stream may include the long-term encoding scheme information as parameter information.

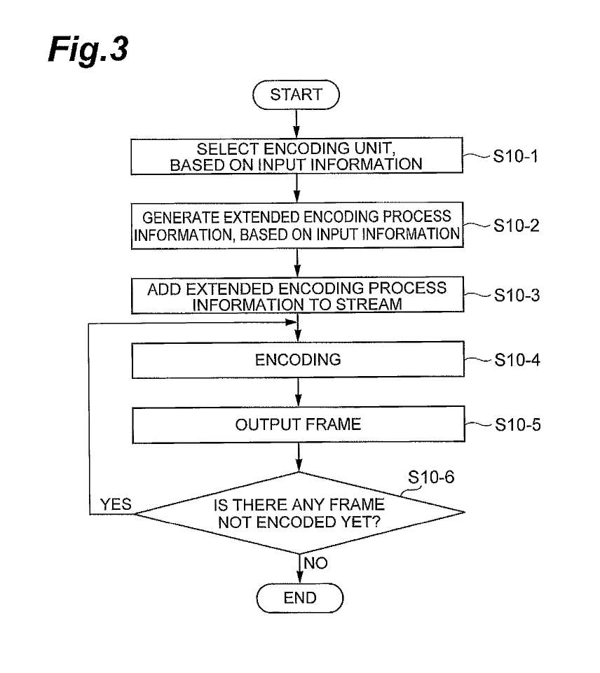

Described below is an operation of the audio encoding device 10 and an audio encoding method of an embodiment. FIG. 3 is a flowchart showing the audio encoding method according to an embodiment. In the embodiment, as shown in FIG. 3, in step S10-1, the selection unit 10b selects one encoding unit from the encoding units 10a₁-10aₙ, based on the input information.

Next, in step S10-2, the generation unit 10c generates long-term encoding scheme information, based on the input information. In step S10-3, the output unit 10d adds the long-term encoding scheme information as parameter information to the first frame.

Next, in step S10-4, the encoding unit selected by the selection unit 10b encodes an audio signal of a current encoding target frame to generate a coded sequence. In subsequent step S10-5, the output unit 10d adds the coded sequence, generated by the encoding unit, into an output frame in a stream corresponding to the encoding target frame and outputs the output frame.

In subsequent step S10-5, it is determined whether there is any frame left to be encoded. The process ends when there is no frame left uncoded. On the other hand, when there is a further frame left to be encoded, the processes sequential from step S10-4 are repeated for the target uncoded frame.

According to the audio encoding device 10 and the audio encoding method of an embodiment described above, the long-term encoding scheme information is included only in the first frame in the stream. Namely, no information for specifying the used audio encoding scheme is included in the frames subsequent to the first frame in the stream. Therefore, it is possible to generate an efficient smaller size stream.

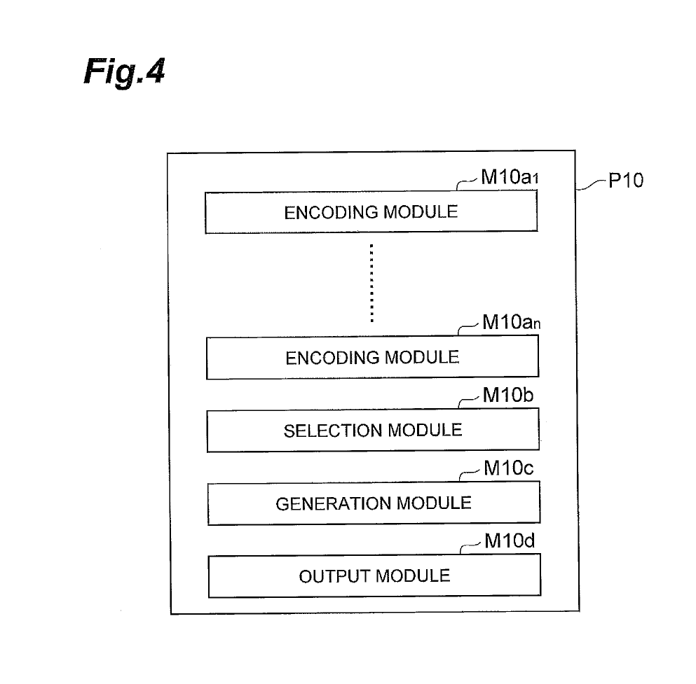

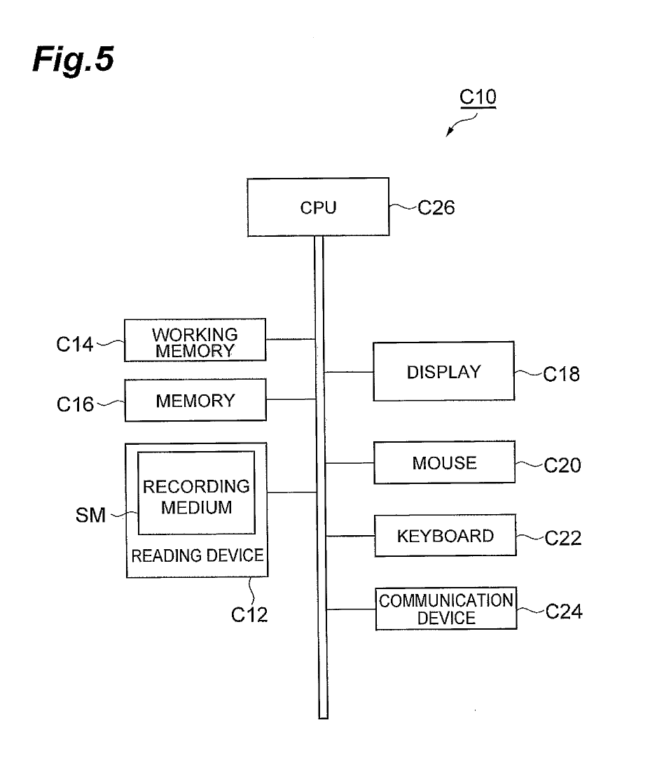

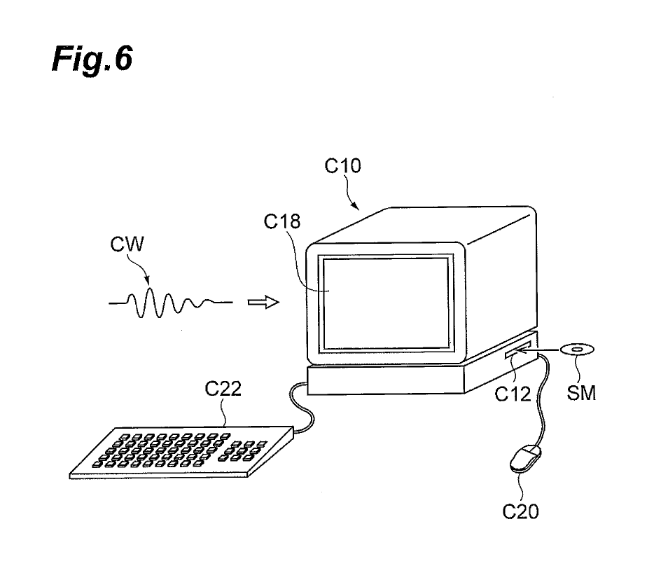

Described below is a program that causes a computer to operate as the audio encoding device 10. FIG. 4 is a drawing showing an audio encoding program according to an embodiment. FIG. 5 is a drawing showing the hardware configuration of a computer according to an embodiment. FIG. 6 is a perspective view showing the computer according to the embodiment. The audio encoding program P10 shown in FIG. 4 causes the computer C10 shown in FIG. 5 to operate as the audio encoding device 10. The program described in the present specification can operates any device, other than the computer shown in FIG. 5, such as a cell phone or a mobile information terminal, according to the program.

The audio encoding program P10 may be stored in a recording medium SM. The recording medium SM may, for example, be a recording medium such as a floppy disk, CD-ROM, DVD, or ROM, or a semiconductor memory or the like.

As shown in FIG. 5, the computer C10 may be provided with a reading device C12 such as a floppy disk drive unit, CD-ROM drive unit, or DVD drive unit, a working memory (RAM) C14 in which an operating system resides, a memory C16 to store a program recorded in the recording medium SM, a monitor device C18 such as a display, a mouse C20 and a keyboard C22 as input devices, a communication device C24 to perform transmission and reception of data or the like, and a CPU C26 to control the execution of the program.

When the recording medium SM is incorporated into the reading device C12, the computer C10 becomes accessible to the audio encoding program P10 stored in the recording medium SM, through the reading device C12, and becomes able to operate as the audio encoding device 10 according to the program P10.

As shown in FIG. 6, the audio encoding program P10 may be provided through a network in the form of a computer data signal CW superimposed on a carrier wave. In this case, the computer C10 can store the audio encoding program P10 received by the communication device C24 into the memory C16 and execute the program P10.

As shown in FIG. 4, the audio encoding program P10 is provided with a plurality of encoding modules M10a₁-M10aₙ, a selection module M10b, a generation module M10c, and an output module M10d.

In one embodiment, the encoding module sections M10a₁-M10aₙ, the selection module M10b, the generation module M10c, and the output module M10d cause the computer C10 to perform the same functions as performed by the encoding units 10a₁-10aₙ, the selection unit 10b, the generation unit 10c, and the output unit 10d, respectively. According to this audio encoding program P10, the computer C10 becomes able to operate as the audio encoding device 10.

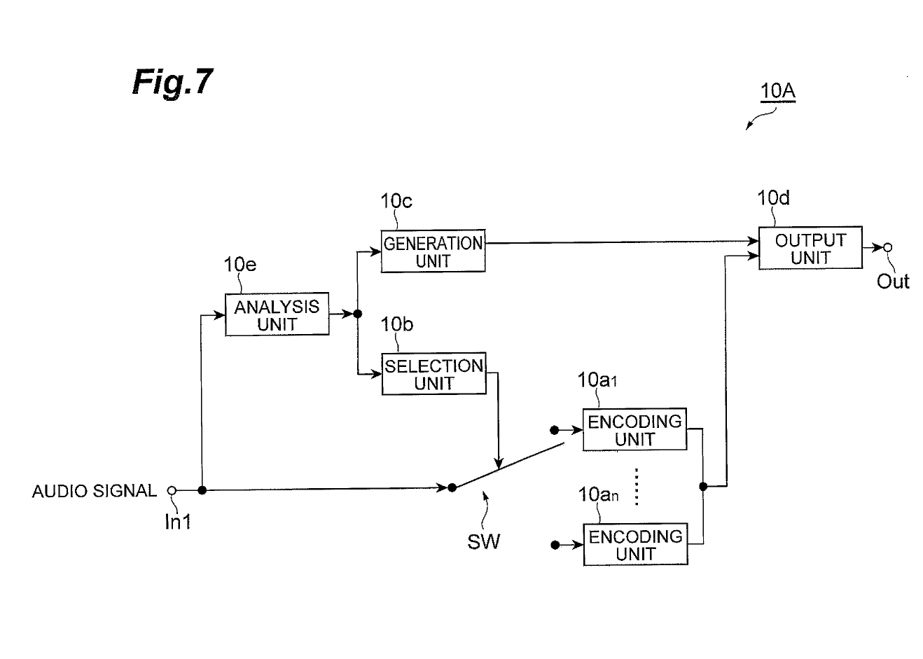

A modified embodiment of the audio encoding device 10 will be described below. FIG. 7 is a drawing showing an audio encoding device according to the modification embodiment. The encoding unit (encoding scheme) of the audio encoding device 10 is selected based on input information. On the other hand, an encoding unit of an audio encoding device 10A shown in FIG. 7 is selected based on a result of an analysis made on an audio signal. For this purpose, the audio encoding device 10A is provided with an analysis unit 10e.

The analysis unit 10e analyzes audio signals of multiple frames to determine an audio encoding scheme suitable to encode the audio signals of the multiple frames. The analysis unit 10e supplies information for specifying the determined audio encoding scheme to the selection unit 10b to instruct the selection unit 10b to select a encoding unit to execute the audio encoding scheme. Furthermore, the analysis unit 10e supplies the information for specifying the determined audio encoding scheme to the generation unit 10c to instruct the generation unit 10c to generate a long-term encoding scheme information.

The analysis unit 10e may analyze, for example, a tonality, a pitch period, a temporal envelope, or a transient component (sudden signal rise/fall) of an audio signal. For example, when a tonality of the audio signal is stronger than a predetermined tonality, the analysis unit 10e may determine to use an audio encoding scheme that performs encoding in the frequency domain. Furthermore, for example, when a pitch period of the audio signal is within a predetermined range, the analysis unit 10e may determine to use an audio encoding scheme suitable to encode the audio signal. Furthermore, for example, when a variation of the temporal envelope of the audio signal is larger than a predetermined variation or when the audio signal includes a transient component, the analysis unit 10e may determine to use an audio encoding scheme that performs encoding in the time domain.

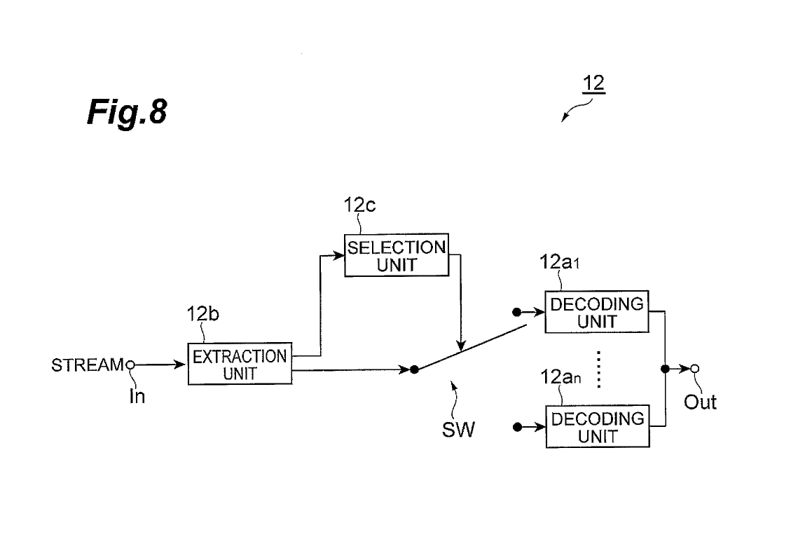

Described below is an audio decoding device that decodes a stream generated by the audio encoding device 10. FIG. 8 is a drawing showing an audio decoding device according to an embodiment. An audio decoding device 12 shown in FIG. 8 is comprised of a plurality of decoding units 12a₁-12aₙ, an extraction unit 12b, and a selection unit 12c. The decoding units 12a₁-12aₙ each execute a different audio decoding scheme to generate audio signals from coded sequences. The schemes performed by the decoding units 12a₁-12aₙ are complementary to the schemes performed by the encoding units 10a₁-10aₙ.

The extraction unit 12b extracts a long-term encoding scheme information (cf. FIG. 3) from a stream fed to an input terminal In. The extraction unit 12b supplies the extracted long-term encoding scheme information to the selection unit 12c and outputs the rest of the stream exclusive of the long-term encoding scheme information to a switch SW.

The selection unit 12c controls a switch SW, based on the long-term encoding scheme information. The selection unit 12c selects, from the decoding units 12a₁-12aₙ, a decoding unit to execute a decoding scheme specified based on the long-term encoding scheme information. The selection unit 12c controls the switch SW so as to connect multiple frames in the stream to the selected decoding unit.

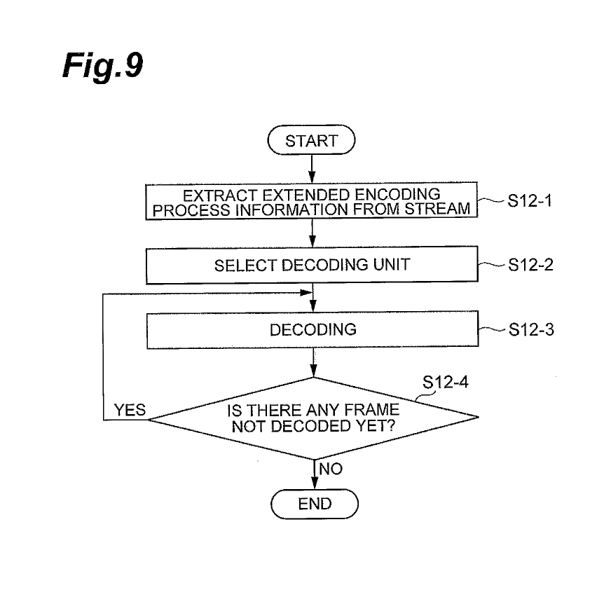

Described below is an operation of the audio decoding device 12 and an audio decoding method according to an embodiment. FIG. 9 is a flowchart showing an audio decoding method according to an embodiment. In the embodiment, as shown in FIG. 9, in step S12-1, the extraction unit 12b extracts a long-term encoding scheme information from a stream. In step S12-2, the selection unit 12c selects one decoding unit from the decoding units 12a₁-12an according to the extracted long-term encoding scheme information.

In step S12-3, the selected decoding unit decodes a coded sequence of a decoding target frame. Next, it is determined in step S12-4 whether there is any frame left to be decoded. When there is no frame left undecoded, the process ends. On the other hand, when there is a frame left to be decoded, the processes including step S12-3 are repeated for a target frame, using the decoding unit selected in step S12-2.

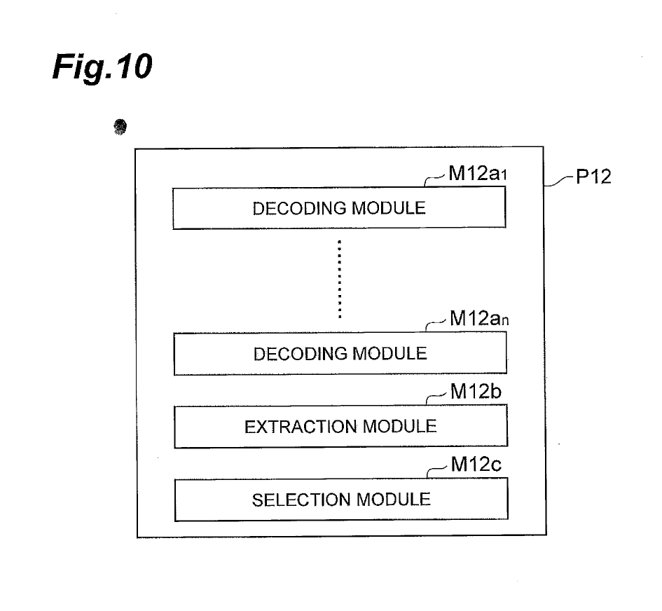

Described below is an audio decoding program that causes a computer to operate as the audio decoding device 12. FIG. 10 shows an audio decoding program according to one embodiment.

An audio decoding program P12 shown in FIG. 10 may be executed in the computer shown in FIGS. 5 and 6. The audio decoding program P12 may be provided in the same manner as the audio encoding program P10 is provided.

As shown in FIG. 10, the audio decoding program P12 is comprised of decoding modules M12a₁-M12aₙ, an extraction module M12b, and a selection module M12c. The decoding modules M12a₁-M12aₙ, the extraction module M12b, and the selection module M12c cause the computer C10 to perform the same functions as performed by the decoding units 12a₁-12aₙ, the extraction unit 12b, and the selection unit 12c, respectively.

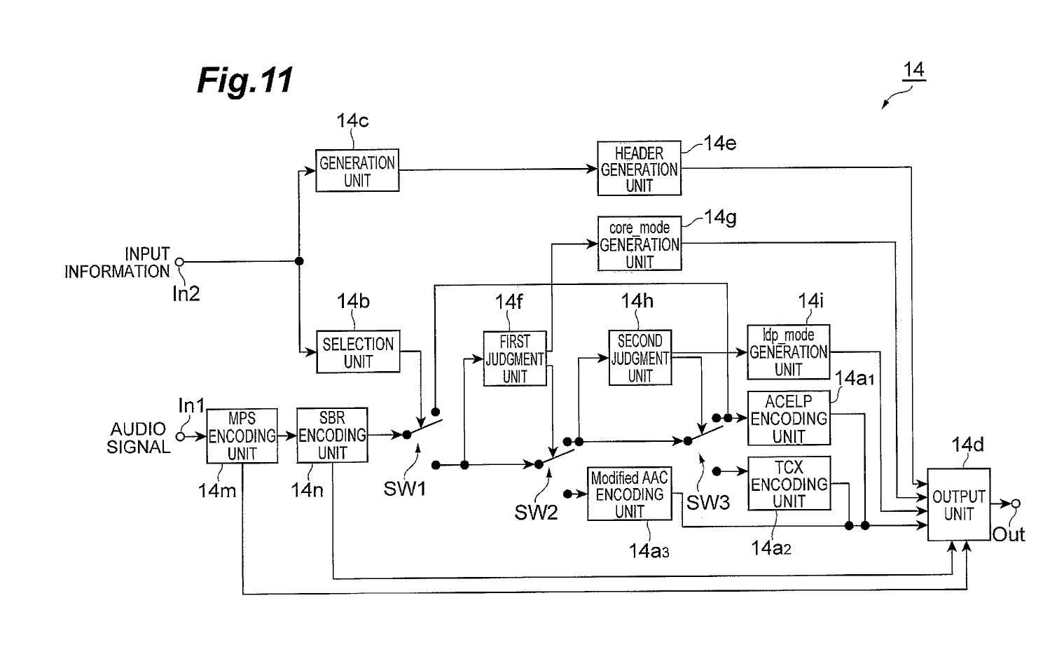

Described below is an audio encoding device according to another embodiment. FIG. 11 is a drawing showing an audio encoding device according to another embodiment. An audio encoding device 14 shown in FIG. 11 may be used in an extension of MPEG USAC.

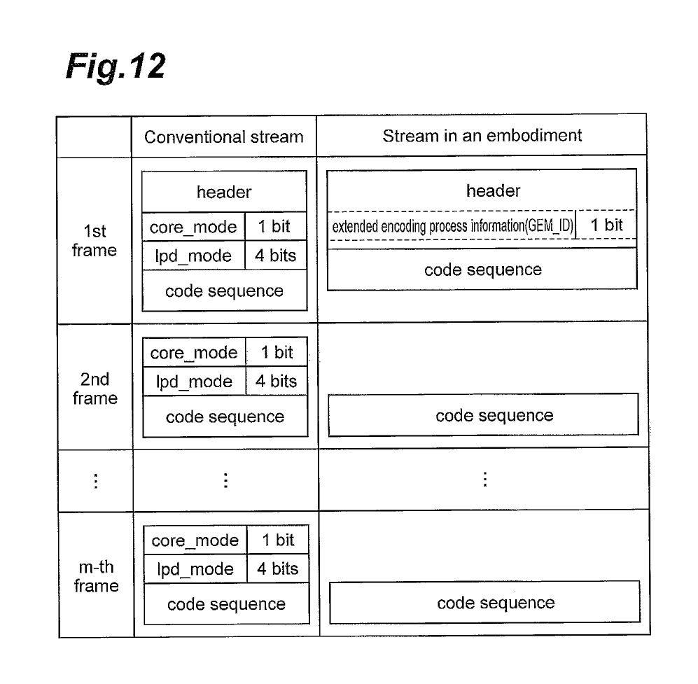

FIG. 12 shows a stream generated according to the conventional MPEG USAC and a stream generated by the audio encoding device shown in FIG. 11. As shown in FIG. 12, in the conventional MPEG USAC, each frame in the stream is added with information i.e., with 1-bit core_mode, indicating whether FD (Modified AAC) or LPD (ACELP or TCX) was used. In the conventional MPEG USAC, a frame on which LPD is performed has a super-frame structure including four frames. When LPD is performed, a super-frame is added with information i.e., 4-bit lpd_mode, indicating whether ACELP or TXC was performed to encode each of frames in the super-frame.

The audio encoding device 14 shown in FIG. 11 encodes audio signals of all frames by a common audio encoding scheme. The audio encoding device 14 also selectively perform an audio encoding scheme on the respective frames, frame by frame, in the same manner as in the case of the conventional MPEG USAC. In one embodiment, the audio encoding device may use LPD, i.e., a set of audio encoding schemes, commonly on every super-frame.

As shown in FIG. 11, the audio encoding device 14 is comprised of an ACELP encoding unit 14a₁, a TCX encoding unit 14a₂, a Modified AAC encoding unit 14a₃, a selection unit 14b, a generation unit 14c, an output unit 14d, a header generation unit 14e, a first judgment unit 14f, a core_mode generation unit 14g, a second judgment unit 14h, an lpd_mode generation unit 14i, an MPS encoding unit 14m, and an SBR encoding unit 14n.

The MPS encoding unit 14m receives an audio signal fed to an input terminal In1. The audio signal fed to the MPS encoding unit 14m may be a multichannel audio signal of two or more channels. The MPS encoding unit 14m expresses a multichannel audio signal of each frame with an audio signal of channels whose channel number is less than the number of channels in the multichannel signal and a parameter for decoding the multichannel audio signal from the audio signal of channels whose channel number is less than the aforementioned number.

When the multichannel audio signal is a stereo signal, the MPS encoding unit 14m downmixes the stereo signal to a monaural audio signal. The MPS encoding unit 14m generates a level difference, a phase difference, and/or a correlation value between the monaural signal and each channel of the stereo signal, as a parameter for decoding the stereo signal from the monaural signal. The MPS encoding unit 14m outputs the generated monaural signal to the SBR encoding unit 14n and outputs encoded data obtained by encoding the generated parameter to the output unit 14d. The stereo signal may be expressed with the monaural signal and a residual signal and with the parameter.

The SBR encoding unit 14n receives the audio signal of each frame from the MPS encoding unit 14m. The audio signal received by the SBR encoding unit 14n may, for example, be the aforementioned monaural signal. When the audio signal fed to the input terminal In1 is a monaural signal, the SBR encoding unit 14n accepts the audio signal. With reference to a predetermined frequency, the SBR encoding unit 14n generates a low frequency band audio signal and a high frequency band audio signal from the input audio signal. Furthermore, the SBR encoding unit 14n calculates a parameter for generating the high frequency band audio signal from the low frequency band audio signal. The parameter to be used herein can, for example, be any information such as frequency information indicative of the predetermined frequency, time-frequency resolution information, spectrum envelope information, additive noise information, and additive sinusoidal information. The SBR encoding unit 14n outputs the low frequency band audio signal to a switch SW1. Furthermore, the SBR encoding unit 14n outputs encoded data obtained by encoding the calculated parameter to the output unit 14d.

The encoding unit 14a₁ encodes the audio signal with the ACELP encoding scheme to generate a coded sequence. The encoding unit 14a₂ encodes the audio signal with the TCX encoding scheme to generate a coded sequence. The encoding unit 14a₃ encodes the audio signal with the Modified AAC encoding scheme to generate a coded sequence.

The selection unit 14b selects an encoding unit to encode audio signals of multiple frames fed to the switch SW1, according to the input information fed to the input terminal In2. In the present embodiment, the input information may be entered by a user. The input information may indicate whether multiple frames are to be encoded with a common encoding scheme.

In the present embodiment, when the input information indicates that multiple frames are to be encoded with a common audio encoding scheme, the selection unit 14b selects a predetermined encoding unit to execute the predetermined encoding scheme. For example, when the input information indicates that multiple frames are to be encoded by a common audio encoding scheme, as described, the selection unit 14b controls the switch SW1 to select the ACELP encoding unit 14a₁ as the predetermined encoding unit. In the present embodiment, therefore, when the input information indicates that multiple frames are to be encoded by a common audio encoding scheme, the ACELP encoding unit 14a₁ encodes the audio signals of the multiple frames.

On the other hand, when the input information indicates that multiple frames are not to be encoded by a common audio encoding scheme, the selection unit 14b connects the audio signal of each frame fed to the switch SW1 to a path leading to the first judgment unit 14f and others.

The generation unit 14c generates the long-term encoding scheme information, based on the input information. As shown in FIG. 12, the long-term encoding scheme information to be used may be a 1-bit GEM_ID. When the input information indicates that multiple frames are to be encoded by a common audio encoding scheme, the generation unit 14c sets GEM_ID to the value “1.” On the other hand, when the input information indicates that multiple frames are not to be encoded by a common audio encoding scheme, the generation unit 14c sets GEM_ID to the value “0.”

The header generation unit 14e generates a header to be included in a stream, and adds the set value of GEM_ID into the header. As shown in FIG. 12, this header is included in the first frame, when outputted from the output unit 14d.

When the input information indicates that multiple frames are not to be encoded by a common audio encoding scheme, the first judgment unit 14f receives an audio signal of an encoding target frame via the SW1. The first judgment unit 14f analyzes the audio signal of the encoding target frame to judge whether the audio signal is to be encoded by the Modified AAC encoding unit 14a₃.

When the first judgment unit 14f determines that the audio signal of the encoding target frame is to be encoded by the Modified AAC encoding unit 14a₃, it controls a switch SW2 to connect the frame to the Modified AAC encoding unit 14a₃.

On the other hand, when the first judgment unit 14f determines that the audio signal of the encoding target frame is not to be encoded by the Modified AAC encoding unit 14a₃, it controls the switch SW2 to connect the frame to the second judgment unit 14h and a switch SW3. In this case, the encoding target frame is divided into four frames in a subsequent process and is handled as a super-frame including the four frames.

The first judgment unit 14f may, for example, analyzes the audio signal of the encoding target frame and when the audio signal has tone components over a predetermined amount, selects the Modified AAC encoding unit 14a₃ as an encoding unit for the speech signal of the frame.

The core_mode generation unit 14g generates core_mode according to the judgment result by the first judgment unit 14f. As shown in FIG. 12, core_mode is 1-bit information. When the first judgment unit 14f determines that the audio signal of the encoding target frame is to be encoded by the Modified AAC encoding unit 14a₃, the core_mode generation unit 14g sets core_mode to the value “0.” On the other hand, when the first judgment unit 14f determines that the audio signal of the judgment target frame is not to be encoded by the Modified AAC encoding unit 14a₃, the core_mode generation unit 14g sets core_mode to the value “1.” This core_mode is added as parameter information to an output frame in a stream corresponding to the encoding target frame, when outputted from the output unit 14d.

The second judgment unit 14h receives an audio signal of an encoding target super-frame via the switch SW2. The second judgment unit 14h judges whether an audio signal of each frame in the encoding target super-frame is to be encoded by the ACELP encoding unit 14a₁ or by the TCX encoding unit 14a₂.

When the second judgment unit 14h determines that the audio signal of the encoding target frame is to be encoded by the ACELP encoding unit 14a₁, it controls the switch SW3 to connect the audio signal of the frame to the ACELP encoding unit 14a₁. On the other hand, when the second judgment unit 14h determines that the audio signal of the encoding target frame is to be encoded by the TCX encoding unit 14a₂, it controls the switch SW3 to connect the audio signal of the frame to the TCX encoding unit 14a₂.

For example, when the audio signal of the encoding target frame is a signal with a strong voice component, when a temporal envelope of the audio signal varies greater than a predetermined variation in a short period, or when the audio signal contains a transient component, the second judgment unit 14h may determine that the audio signal is to be encoded by the ACELP encoding unit 14a₁. Otherwise, the second judgment unit 14h may determine that the audio signal is to be encoded by the TCX encoding unit 14a₂. The audio signal may be determined to include a strong voice component when a pitch period of the audio signal is within a predetermined range, when an autocorrelation among pitch periods is stronger than a predetermined autocorrelation, or when a zero-cross rate is smaller than a predetermined rate.

The lpd_mode generation unit 14i generates lpd_mode according to the judgment result by the second judgment unit 14h. As shown in FIG. 12, lpd_mode is 4-bit information. The lpd_mode generation unit 14i sets the value of lpd_mode to a predetermined value corresponding to the judgment result from the second judgment unit 14h on the audio signal of each frame in the super-frame. The value of lpd_mode set by the lpd_mode generation unit 14i is added to an output super-frame in a stream corresponding to the encoding target super-frame, when outputted from the output unit 14d.

The output unit 14d outputs a stream. The stream contains the first frame with the header including the aforementioned GEM_ID and a corresponding coded sequence and contains the second to m-th frames (m is an integer not less than 2) added with respective corresponding coded sequences. Furthermore, the output unit 14d adds in each output frame the encoded data of the parameter generated by the MPS encoding unit 14m and the encoded data of the parameter generated by the SBR encoding unit 14n.

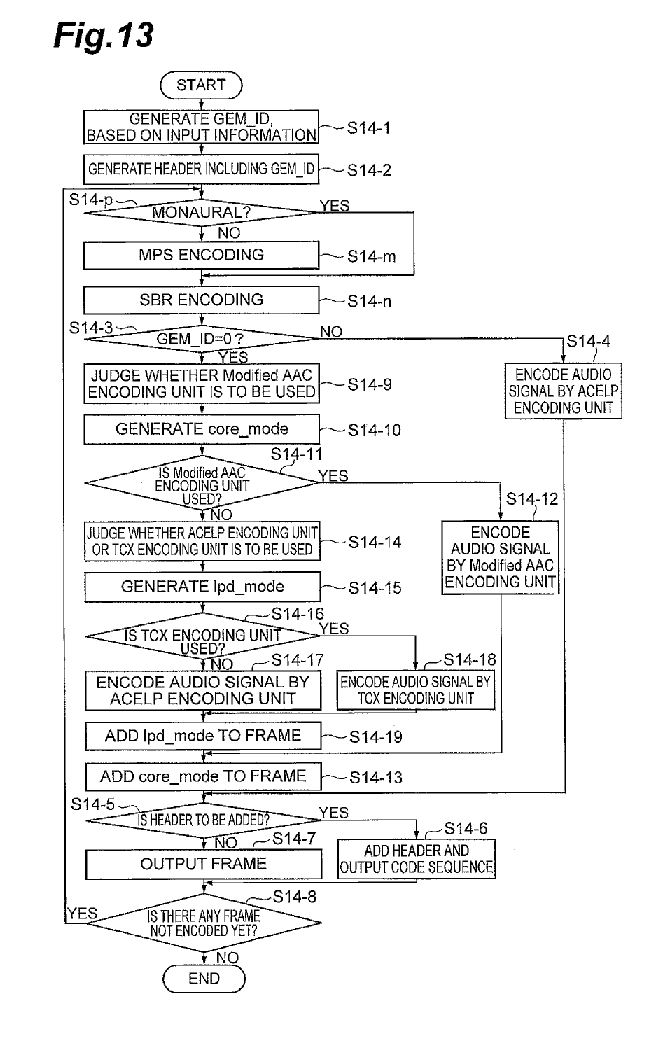

Described below is an operation of the audio encoding device 14 and an audio encoding method according to another embodiment. FIG. 13 is a flowchart of the audio encoding method according to the embodiment.

In one embodiment, as shown in FIG. 13, in step S14-1, the generation unit 14c generates (or sets) GEM_ID as described above, based on the input information. In subsequent step S14-2, the header generation unit 14e generates a header including the set GEM_ID.

Next, when it is determined by a judgment in step S14-p that an audio signal fed to the input terminal In1 is a multichannel signal, step S14-m is carried out in which the MPS encoding unit 14m generates, from the multichannel audio signal of the input encoding target frame, an audio signal of channels whose channel number is less than the number of channels of the multichannel signal and a parameter for decoding of the multichannel audio signal from the audio signal of channels whose channel number is less than the foregoing number, as described above. The MPS encoding unit 14m generates encoded data of the parameter. This encoded data is added in a corresponding output frame by the output unit 14d. On the other hand, when the audio signal fed to the input terminal In1 is a monaural signal, the MPS encoding unit 14m does not operate such that the audio signal fed to the input terminal In1 is fed to the SBR encoding unit 14n.

Next, in step S14-n, the SBR encoding unit 14n generates a low frequency band audio signal from the input audio signal and a parameter for generation of a high frequency band audio signal from the low frequency band audio signal, as described above. The SBR encoding unit 14n generates encoded data of the parameter. This encoded data is added in a corresponding output frame by the output unit 14d.

Next, in step S14-3, the selection unit 14b judges whether audio signals of multiple frames, i.e., low frequency band audio signals of multiple frames outputted from the SBR encoding unit 14n, are to be encoded by a common audio encoding scheme, based on the input information.

When in step S14-3, the input information indicates that audio signals of multiple frames are to be encoded by a common audio encoding scheme, i.e., when the value of GEM_ID is “1,” the selection unit 14b selects the ACELP encoding unit 14a₁.

Next, in step S14-4, the ACELP encoding unit 14a₁ selected by the selection unit 14b encodes an audio signal of an encoding target frame to generate a coded sequence.

Next, in step S14-5, the output unit 14d determines whether a header is to be added to a frame. In step S14-5, when the encoding target frame is the first frame, the output unit 14d determines that the header is to be added to the first frame in the stream corresponding to the encoding target frame, and in subsequent step S14-6, the output unit 14d adds the header and coded sequence in the first frame and outputs the first frame. On the other hand, when the target frame is the second frame or a frame subsequent thereto, no header is added and, in step S14-7, the output unit 14d adds a coded sequence in the frame and outputs it.

Next, it is determined in step S14-8 whether there is any frame left to be encoded. When there is no frame left uncoded, the process ends. On the other hand, there is a frame left to be encoded, the process from step S14-p is repeated for a target frame left to be encoded.

In the present embodiment, as described above, while the value of GEM_ID is “1,” the ACELP encoding unit 14a₁ is continuously used to encode all audio signals of multiple frames.

When it is determined in step S14-3 that the value of GEM_ID is “0,” i.e., when the input information indicates that each frame is to be processed by an individual encoding scheme method, step S14-9 is carried out in which the first judgment unit 14f judges whether the audio signal of the encoding target frame, i.e., the low frequency band audio signal of the encoding target frame outputted from the SBR encoding unit 14n is to be encoded by the Modified AAC encoding unit 14a₃. In subsequent step S14-10, the core_mode generation unit 14g sets the value of core_mode to a value according to the judgment result by the first judgment unit 14f.

Next, it is determined in step S14-11 whether the judgment result by the first judgment unit 14f indicates that the audio signal of the encoding target frame is to be encoded by the Modified AAC encoding unit 14a₃. When the judgment result by the first judgment unit 14f indicates that the audio signal of the encoding target frame is to be encoded by the Modified AAC encoding unit 14a₃, subsequent step S14-12 is carried out in which the audio signal of the encoding target frame is encoded by the Modified AAC encoding unit 14a₃.

Next, in step S14-13, the output unit 14d adds core_mode to an output frame (or super-frame) in the stream corresponding to the encoding target frame. Then, the process proceeds to step S14-5.

When, in step S14-11, the judgment result by the first judgment unit 14f indicates that the audio signal of the encoding target frame is not to be encoded by the Modified AAC encoding unit 14a₃, the process from step S14-14 is carried out so as to process the encoding target frame as a super-frame.

In step S14-14, the second judgment unit 14h judges whether each frame in the super-frame is to be encoded by the ACELP encoding unit 14a₁ or by the TCX encoding unit 14a₂. In subsequent step S14-15, the lpd_mode generation unit 14i sets lpd_mode to a value according to the judgment result by the second judgment unit 14h.

Next, it is judged in step S14-16 whether the judgment result by the second judgment unit 14h indicates that the encoding target frame in the super-frame is to be encoded by the ACELP encoding unit 14a₁ or indicates that the encoding target frame is to be encoded by the TCX encoding unit 14a₂.

When the judgment result by the second judgment unit 14h indicates that the encoding target frame is to be encoded by the ACELP encoding unit 14a₁, step S14-17 is carried out in which the audio signal of the encoding target frame is encoded by the ACELP encoding unit 14a₁. On the other hand, when the judgment result by the second judgment unit 14h indicates that the encoding target frame is to be encoded by the TCX encoding unit 14a₂, step S14-18 is carried out in which the audio signal of the encoding target frame is encoded by the TCX encoding unit 14a₂.

Next, in step S14-19, lpd_mode is added to an output super-frame in the stream corresponding to the encoding target super-frame. Then the process proceeds to step S14-13.

According to the audio encoding device 14 and the audio encoding method described above, since GEM_ID set to “1” is included in the header, the decoder side is notified that audio signals of multiple frames were encoded only by the ACELP encoding unit, eliminating the need to include information for specifying the audio encoding scheme used in each frame. Therefore, a smaller size stream is generated.

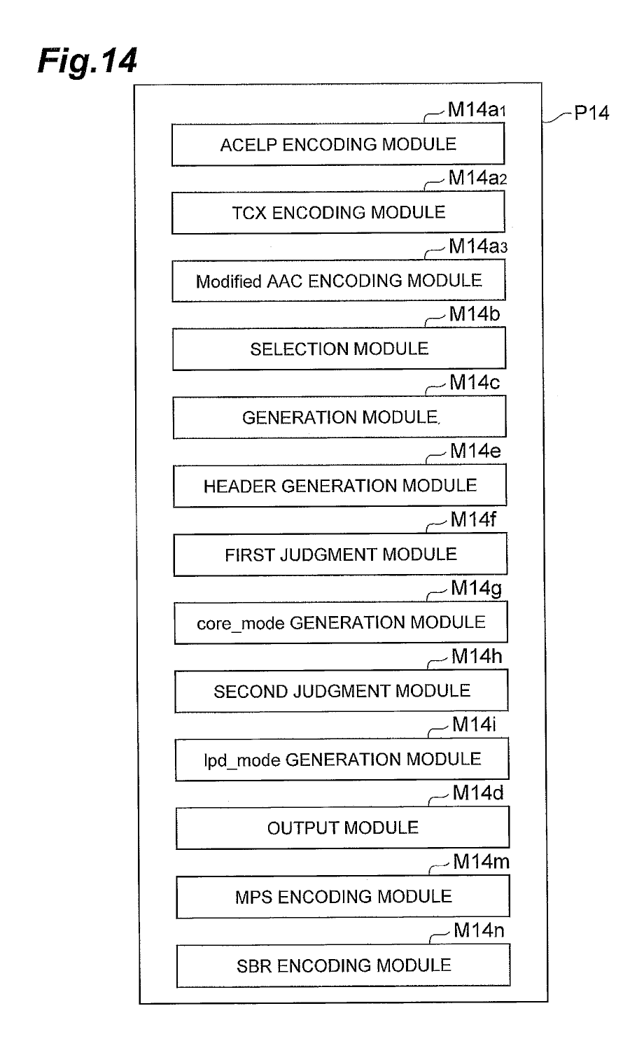

Described below is an audio encoding program that causes a computer to operate as the audio encoding device 14. FIG. 14 is a drawing showing the audio encoding program according to another embodiment.

The audio encoding program P14 shown in FIG. 14 may be executed in the computer shown in FIGS. 5 and 6. The audio encoding program P14 may be provided in the same manner as the audio encoding program P10.

As shown in FIG. 14, the audio encoding program P14 is comprises of an ACELP encoding module M14a₁, a TCX encoding module M14a₂, a Modified AAC encoding module M14a₃, a selection module M14b, a generation module M14c, an output module M14d, a header generation module M14e, a first judgment module M14f, a core_mode generation module M14g, a second judgment module M14h, an lpd_mode generation module M14i, an MPS encoding module M14m, and an SBR encoding module 14n.

The ACELP encoding module M14a₁, the TCX encoding module M14a₂, the Modified AAC encoding module M14a₃, the selection module M14b, the generation module M14c, the output module M14d, the header generation module M14e, the first judgment module M14f, the core_mode generation module M14g, the second judgment module M14h, the lpd_mode generation module M14i, the MPS encoding module M14m, and the SBR encoding module 14n cause the computer C10 to perform the same functions as performed by the ACELP encoding unit 14a₁, the TCX encoding unit 14a₂, the Modified AAC encoding unit 14a₃, the selection unit 14b, the generation unit 14c, the output unit 14d, the header generation unit 14e, the first judgment unit 14f, the core_mode generation unit 14g, the second judgment unit 14h, lpd_mode generation unit 14i, the MPS encoding unit 14m, and the SBR encoding unit 14n, respectively.

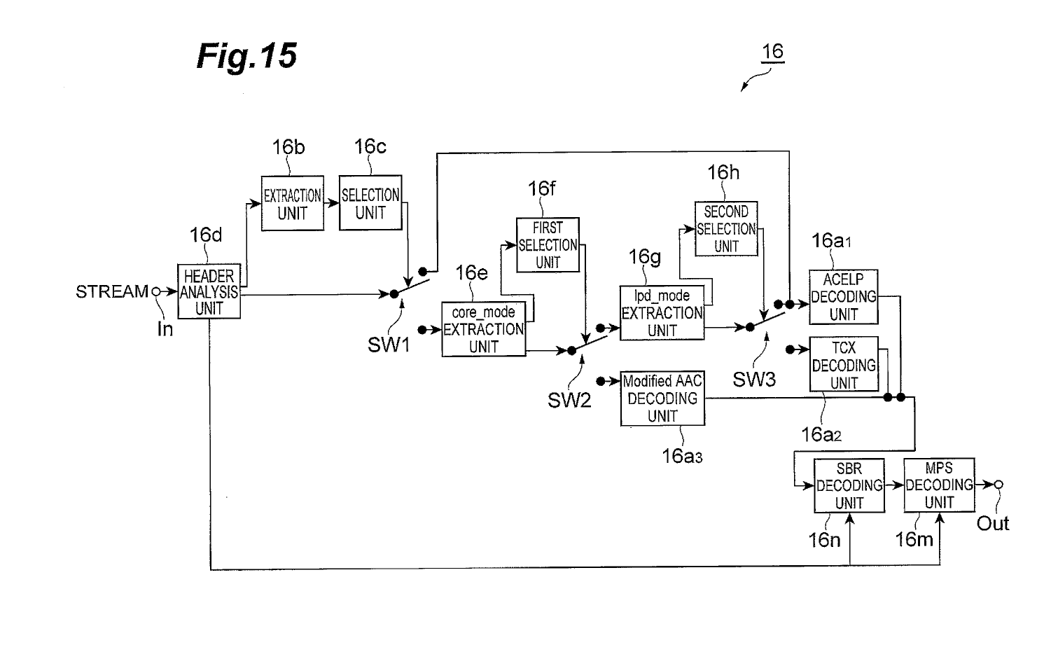

Described below is an audio decoding device that decodes a stream generated by the audio encoding device 14. FIG. 15 is a drawing showing an audio decoding device according to another embodiment. an audio decoding device 16 shown in FIG. 15 is comprised of an ACELP decoding unit 16a₁, a TCX decoding unit 16a₂, a Modified AAC decoding unit 16a₃, an extraction unit 16b, a selection unit 16c, a header analysis unit 16d, a core_mode extraction unit 16e, a first selection unit 16f, an lpd_mode extraction unit 16g, a second selection unit 16h, an MPS decoding unit 16m, and an SBR decoding unit 16n.

The ACELP decoding unit 16a₁ decodes a coded sequence in a frame by the ACELP decoding scheme to generate an audio signal. The TCX decoding unit 16a₂ decodes a coded sequence in a frame by the TCX decoding scheme to generate an audio signal. The Modified AAC decoding unit 16a₃ decodes a coded sequence in a frame by the Modified AAC decoding scheme to generate an audio signal. In one embodiment, the audio signals outputted from these decoding units are the low frequency band audio signals described above with reference to the audio encoding device 14.

The header analysis unit 16d separates the header from the first frame. The header analysis unit 16d provides the separated header to the extraction unit 16b and outputs the first frame from which the header is separated, and the subsequent frames to the switch SW1, the MPS decoding unit 16m, and the SBR decoding unit 16n.

The extraction unit 16b extracts GEM_ID from the header. The selection unit 16c selects a decoding unit to be used to decode coded sequences of multiple frames, according to extracted GEM_ID. Specifically, when the value of GEM_ID is “1,” the selection unit 16c controls the switch SW1 to connect all the frames to the ACELP decoding unit 16a₁. On the other hand, when the value of GEM_ID is “0,” the selection unit 16c controls the switch SW1 to connect a decoding target frame (or super-frame) to the core_mode extraction unit 16e.

The core_mode extraction unit 16e extracts core_mode from the decoding target frame (or super-frame) and provides extracted core_mode to the first selection unit 16f. The first selection unit 16f controls the switch SW2 according to the provided value of core_mode. Specifically, when the value of core_mode is “0,” the first selection unit 16f controls the switch SW2 to connect the decoding target frame to the Modified AAC decoding unit 16a₃. Thereafter, the decoding target frame is fed to the Modified AAC decoding unit 16a₃. On the other hand, when the value of core_mode is “1,” the first selection unit 16f controls the switch SW2 to connect the decoding target super-frame to the lpd_mode extraction unit 16g.

The lpd_mode extraction unit 16g extracts lpd_mode from the decoding target frame, i.e., from the super-frame. The lpd_mode extraction unit 16g connects extracted lpd_mode to the second selection unit 16h. The second selection unit 16h connects each frame in the decoding target super-frame outputted from the lpd_mode extraction unit 16g to the ACELP decoding unit 16a₁ or to the TCX decoding unit 16a₂, according to input lpd_mode.

Specifically, the second selection unit 16h refers to a predetermined table associated with value of lpd_mode to set a value of mod[k] (k=0, 1, 2, or 3). Then, the second selection unit 16h controls the switch SW3 according to the value of mod[k] to connect each frame in the decoding target super-frame to the ACELP decoding unit 16a₁ or to the TCX decoding unit 16a₂. The relationship between the values of mod[k] and a selection of either the ACELP decoding unit 16a₁ or the TCX decoding unit 16a₂ will be described later.

The SBR decoding unit 16n receives the low frequency band audio signals from the decoding units 16a₁, 16a₂, and 16a₃. The SBR decoding unit 16n also decodes encoded data in the decoding target frame to restore a parameter. The SBR decoding unit 16n generates a high frequency band audio signal, using the low frequency band audio signal and the restored parameter. The SBR decoding unit 16n combines the high frequency band audio signal and the low frequency band audio signal to generate an audio signal.

The MPS decoding unit 16m receives the audio signal from the SBR decoding unit 16n. This audio signal may be a monaural audio signal when the audio signal to be restored is a stereo signal. The MPS decoding unit 16m also decodes encoded data in the decoding target frame to restore a parameter. The MPS decoding unit 16m generates a multichannel audio signal, using the audio signal and restored parameter received from the SBR decoding unit 16n, and outputs the multichannel audio signal. When the audio signal to be restored is a monaural signal, the MPS decoding unit 16m does not operate and outputs the audio signal generated by the SBR decoding unit 16n.

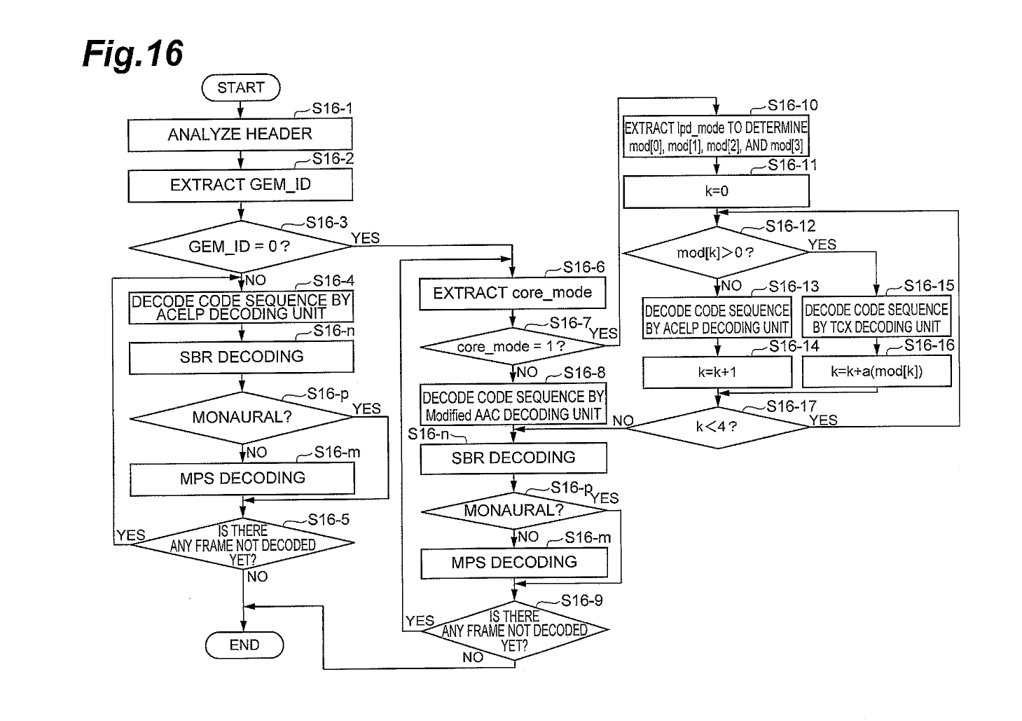

Described below is an operation of the audio decoding device 16 and an audio decoding method according to another embodiment. FIG. 16 is a flowchart of the audio decoding method according to another embodiment.

In the embodiment, as shown in FIG. 16, in step S16-1, the header analysis unit 16d separates a header from a stream. In subsequent step S16-2, the extraction unit 16b extracts GEM_ID from the header provided from the header analysis unit 16d.

Next, in step S16-3, the selection unit 16c selects a decoding unit to decode multiple frames, according to the value of GEM_ID extracted by the extraction unit 16b. Specifically, when the value of GEM_ID is “1,” the selection unit 16c selects the ACELP decoding unit 16a₁. In this case, in step S16-4, the ACELP decoding unit 16a₁ decodes a coded sequence in the decoding target frame. The audio signal generated in step S16-4 is the aforementioned low frequency band audio signal.

Next, in step S16-n, the SBR decoding unit 16n decodes encoded data in the decoding target frame to restore a parameter. In step S16-n, the SBR decoding unit 16n generates a high frequency band audio signal, using the inputted low frequency band audio signal and the restored parameter. In step S16-n, the SBR decoding unit 16n combines the high frequency band audio signal and the low frequency band audio signal to generate an audio signal.

Next, when it is determined in step S16-p that the target to be processed is a multichannel signal, subsequent step S16-m is carried out in which the MPS decoding unit 16m decodes encoded data in the decoding target frame to restore a parameter. In step S16-m, the MPS decoding unit 16m generates a multichannel audio signal, using the audio signal and restored parameter received from the SBR decoding unit 16n, and outputs the multichannel audio signal. On the other hand, when the processing target is determined to be a monaural signal, the SBR decoding unit 16n outputs the generated audio signal.

Next, it is judged in step S16-5 whether there is any frame left to be decoded. When there is no frame left to be decoded, the process ends. On the other hand, when there is a frame left to be decoded, the process from step S16-4 is repeated for the target frame left to be decoded. By this operation, when the value of GEM_ID is “1,” coded sequences of multiple frames are decoded by a common decoding unit, i.e., by the ACELP decoding unit 16a₁.

Returning to step S16-3, when the value of GEM_ID is “0,” the selection unit 16c connects the decoding target frame to the core_mode extraction unit 16e. In this case, in step S16-6, the core_mode extraction unit 16e extracts core_mode from the decoding target frame.

Next, in step S16-7, the first selection unit 16f selects either the Modified AAC decoding unit 16a₃ or the lpd_mode extraction unit 16g, according to extracted core_mode. Specifically, when the value of core_mode is “0,” the first selection unit 16f selects the Modified AAC decoding unit 16a₃ to connect the decoding target frame to the Modified AAC decoding unit 16a₃. In this case, in subsequent step S16-8, a coded sequence in the target frame to be processed is decoded by the Modified AAC decoding unit 16a₃. The audio signal generated in this step S16-8 is the aforementioned low frequency band audio signal. Subsequent to this step S16-8, the aforementioned SBR decoding scheme (step S16-n) and MPS decoding scheme (step S16-m) are carried out.

Next, it is judged in step S16-9 whether there is any frame left to be decoded, and the process ends when there is no frame left to be decoded. On the other hand, when there is a frame left to be decoded, the process from step S16-6 is repeated for the target frame left to be decoded.

Returning to step S16-7, when the value of core_mode is “1,” the first selection unit 16f selects the lpd_mode extraction unit 16g to connect the decoding target frame to the lpd_mode extraction unit 16g. In this case, the decoding target frame is processed as a super-frame.

Next, in step S16-10, the lpd_mode extraction unit 16g extracts lpd_mode from the decoding target super-frame. Then, the second selection unit 16h sets mod[k] (k=0, 1, 2, or 3) according to extracted lpd_mode.

Next, in step S16-11, the second selection unit 16h sets the value of k to “0.” In subsequent step S16-12, the second selection unit 16h judges whether the value of mod[k] is larger than 0. When the value of mod[k] is not larger than 0, the second selection unit 16h selects the ACELP decoding unit 16a₁. On the other hand, when the value of mod[k] is larger than 0, the second selection unit 16h selects the TCX decoding unit 16a₂.

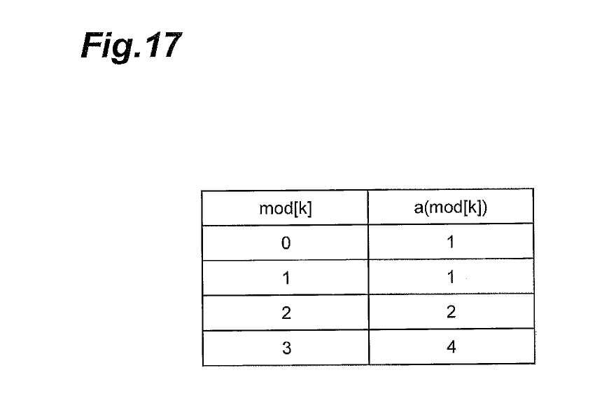

When the ACELP decoding unit 16a₁ is selected, subsequent step S16-13 is carried out in which the ACELP decoding unit 16a₁ decodes the coded sequence of the decoding target frame in the super-frame. Next, in step S16-14, the value of k is set to k+1. On the other hand, when the TCX decoding unit 16a₂ is selected, subsequent step S16-15 is carried out in which the TCX decoding unit 16a₂ decodes the coded sequence of the decoding target frame in the super-frame. In step S16-16, the value of k is updated to k+a (mod[k]). As to the relationship between mod[k] and a(mod[k]), reference should be made to FIG. 17.

It is then judged in step S16-17 whether the value of k is smaller than 4. When the value of k is smaller than 4, the process from step S16-12 is repeated for the subsequent frame in the super-frame. On the other hand, when the value of k is not less than 4, the process proceeds to step S16-n.

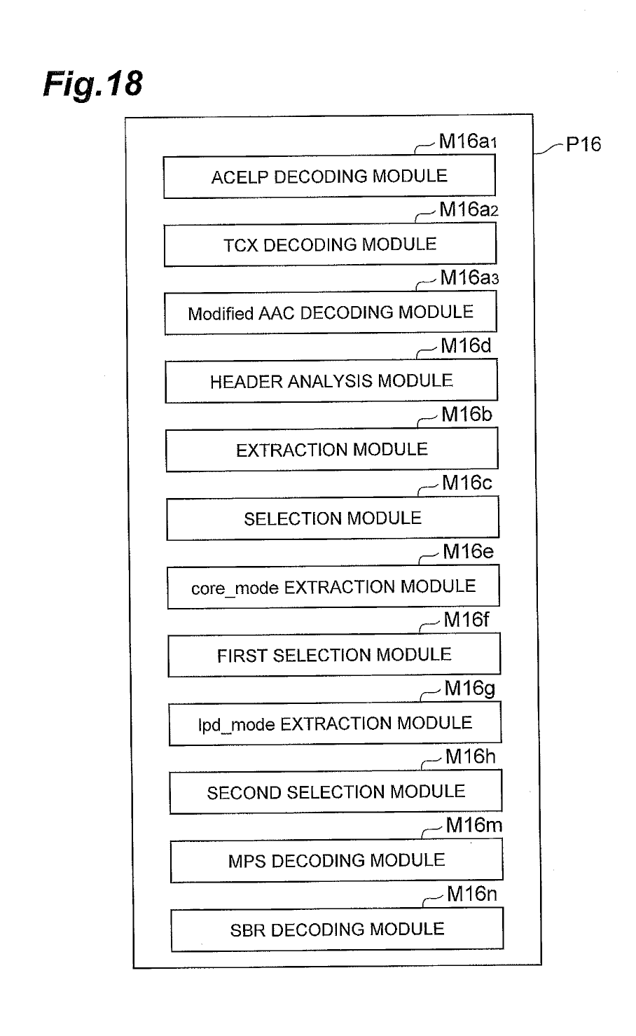

Described below is an audio decoding program for causing a computer to operate as the audio decoding device 16. FIG. 18 is a drawing showing the audio decoding program according to another embodiment.

The audio decoding program P16 shown in FIG. 18 may be executed in the computer shown in FIGS. 5 and 6. The audio decoding program P16 can be provided in the same manner as the audio encoding program P10.

As shown in FIG. 18, the audio decoding program P16 is comprised of an ACELP decoding module M16a₁, a TCX decoding module M16a₂, a Modified AAC decoding module M16a₃, an extraction module M16b, a selection module M16c, a header analysis module M16d, a core_mode extraction module M16e, a first selection module M16f, an lpd_mode extraction module M16g, a second selection module M16h, an MPS decoding module M16m, and an SBR decoding module M16n.

The ACELP decoding module M16a₁, the TCX decoding module M16a₂, the Modified AAC decoding module M16a₃, the extraction module M16b, the selection module M16c, the header analysis module M16d, the core_mode extraction module M16e, the first selection module M16f, the lpd_mode extraction module M16g, the second selection module M16h, the MPS decoding module M16m, and the SBR decoding module M16n cause the computer C10 to perform the same functions as performed by the ACELP decoding unit 16a₁, the TCX decoding unit 16a₂, the Modified AAC decoding unit 16a₃, the extraction unit 16b, the selection unit 16c, the header analysis unit 16d, the core_mode extraction unit 16e, the first selection unit 16f, the lpd_mode extraction unit 16g, the second selection unit 16h, the MPS decoding unit 16m, and the SBR decoding unit 16n, respectively.

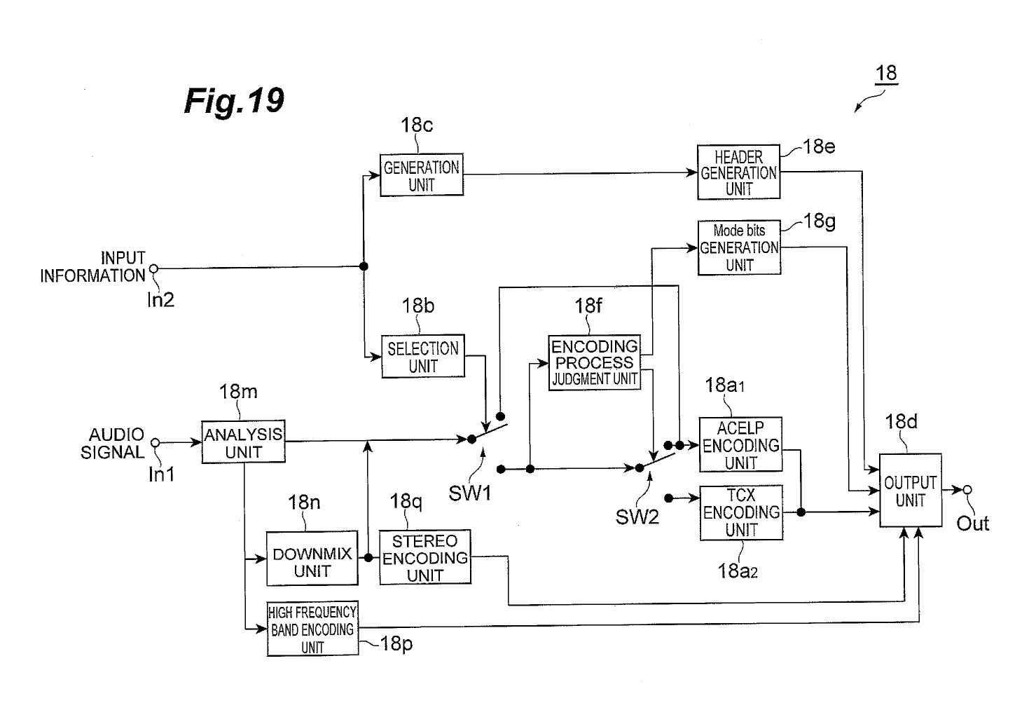

Described below is an audio encoding device according to another embodiment. FIG. 19 is a drawing showing an audio encoding device according to another embodiment. An audio encoding device 18 shown in FIG. 19 may be used as an extension of AMR-WB+.

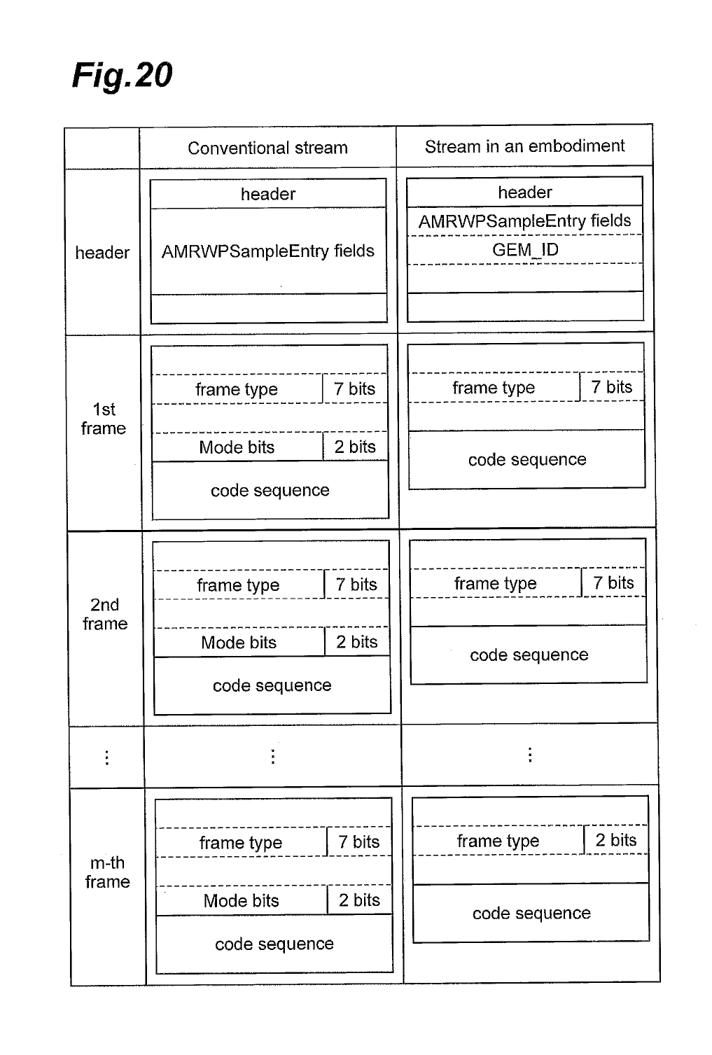

FIG. 20 is a drawing showing a stream generated according to the conventional AMR-WB+ and a stream generated by the audio encoding device shown in FIG. 19. In AMR-WB+, as shown in FIG. 20, each frame is provided with 2-bit Mode bits. Mode bits indicates that either the ACELP encoding scheme or the TCX encoding scheme is to be selected, depending upon its value.

On the other hand, the audio encoding device 18 shown in FIG. 19 encodes audio signals of all frames by a common audio encoding scheme. Furthermore, the audio encoding device 18 also selects an audio encoding scheme used for the respective frames, from one to another.

As shown in FIG. 19, the audio encoding device 18 is provided with an ACELP encoding unit 18a₁ and a TCX encoding unit 18a₂. The ACELP encoding unit 18a₁ encodes an audio signal by the ACELP encoding scheme to generate a coded sequence. The TCX encoding unit 18a₂ encodes an audio signal by the TCX encoding scheme to generate a coded sequence. The audio encoding device 18 is further comprised of a selection unit 18b, a generation unit 18c, an output unit 18d, a header generation unit 18e, an encoding scheme judgment unit 18f, a Mode bits generation unit 18g, an analysis unit 18m, a downmix unit 18n, a high frequency band encoding unit 18p, and a stereo encoding unit 18q.

The analysis unit 18m divides, referring to a predetermined frequency, an audio signal of each frame fed to the input terminal In1 into a low frequency band audio signal and a high frequency band audio signal. When the audio signal fed to the input terminal In1 is a monaural audio signal, the analysis unit 18m outputs the generated low frequency band audio signal to a switch SW1 and outputs the high frequency band audio signal to the high frequency band encoding unit 18p. On the other hand, when the audio signal fed to the input terminal In1 is a stereo signal, the analysis unit 18m outputs the generated low frequency band audio signal (stereo signal) to the downmix unit 18n.

When the audio signal fed to the input terminal In1 is a stereo signal, the downmix unit 18n down-mixes the low frequency band audio signal (stereo signal) to a monaural audio signal. The downmix unit 18n outputs the generated monaural audio signal to the switch SW1. The downmix unit 18n divides, referring to a predetermined frequency, the low frequency band audio signal into audio signals of two frequency bands. The downmix unit 18n outputs an audio signal (monaural signal) of a lower frequency band out of the two frequency band audio signals and the right channel audio signal to the stereo encoding unit 18q.

The high frequency band encoding unit 18p calculates a parameter for enabling the decoder side to generate a high frequency band audio signal from the low frequency band audio signal, generates encoded data of the parameter, and outputs the encoded data to the output unit 18d. The parameter to be used herein may, for example, be a linear predictive coefficient obtained by modeling a spectrum envelope, or a gain for power adjustment.

The stereo encoding unit 18q calculates a side signal, which is a difference signal between the lower frequency band monaural audio signal of the two frequency band audio signals and the right channel audio signal. The stereo encoding unit 18q calculates a balance factor indicative of a level difference between the monaural audio signal and the side signal, encodes the balance factor and a waveform of the side signal, respectively, by predetermined methods, and outputs encoded data to the output unit 18d. The stereo encoding unit 18q calculates a parameter for a decoding device to generate a stereo audio signal from the lower frequency band audio signal of the two frequency band audio signals and outputs encoded data of the parameter to the output unit 18d.

The selection unit 18b has the same function as that of the selection unit 14b. Specifically, when the input information indicates that multiple frames are to be encoded by a common audio encoding scheme, the selection unit 18b controls the switch SW1 to connect audio signals of all frames fed to the switch SW1 to the ACELP encoding unit 18a₁. On the other hand, when the input information indicates that multiple frames are not to be encoded by a common encoding scheme, the selection unit 18b controls the switch SW1 to connect an audio signal of each frame fed to the switch SW1 to a path leading to the encoding scheme judgment unit 18f and others.

The generation unit 18c sets GEM_ID in the same manner as set by the generation unit 14c. The header generation unit 18e generates a header compatible with AMR-WB+ including GEM_ID generated by the generation unit 18c. This header is outputted as the head of the stream by the output unit 18d. In the present embodiment, GEM_ID may be included in an unused region in AMR_WBPSampleEntry_fields of the header.

When the input information indicates that multiple frames are not to be encoded by a common encoding scheme, the encoding scheme judgment unit 18f receives an audio signal of an encoding target frame via the SW1.

The encoding scheme judgment unit 18f processes the encoding target frame as a super-frame such that the encoding target frame is divided into four or less frames. The encoding scheme judgment unit 18f analyzes an audio signal of each frame in the super-frame to judge whether the audio signal is to be encoded by the ACELP encoding unit 18a₁ or to be encoded by the TCX encoding unit 18a₂. This analysis may be the same analysis as performed by the aforementioned second judgment unit 14h.

When the judgment unit 18f determines that the audio signal of the frame is to be encoded by the ACELP encoding unit 18a₁, it controls the switch SW2 to connect the audio signal of the frame to the ACELP encoding unit 18a₁. On the other hand, when the judgment unit 18f determines that the audio signal of the frame is to be encoded by the TCX encoding unit 18a₂, it controls the switch SW2 to connect the audio signal of the frame to the TCX encoding unit 18a₂.

The Mode bits generation unit 18g generates K pieces of Mode Bits[k] (k=0 to K−1) having values according to the judgment result by the encoding scheme judgment unit 18f. The value of K herein is an integer not more than 4 and may be a number corresponding to the number of frames in the super-frame. Furthermore, Mode bits[k] is 2-bit information indicating that either the ACELP encoding scheme or the TCX encoding scheme was used to encode the audio signal of the encoding target frame.

The output unit 18d outputs a stream with a header and multiple frames of corresponding coded sequences. When the value of GEM_ID is 0, the output unit 18d adds Mode bits[k] in the output frame. Furthermore, the output unit 18d adds in a corresponding frame the encoded data generated by the high frequency band encoding unit 18p and the encoded data generated by the stereo encoding unit 18.

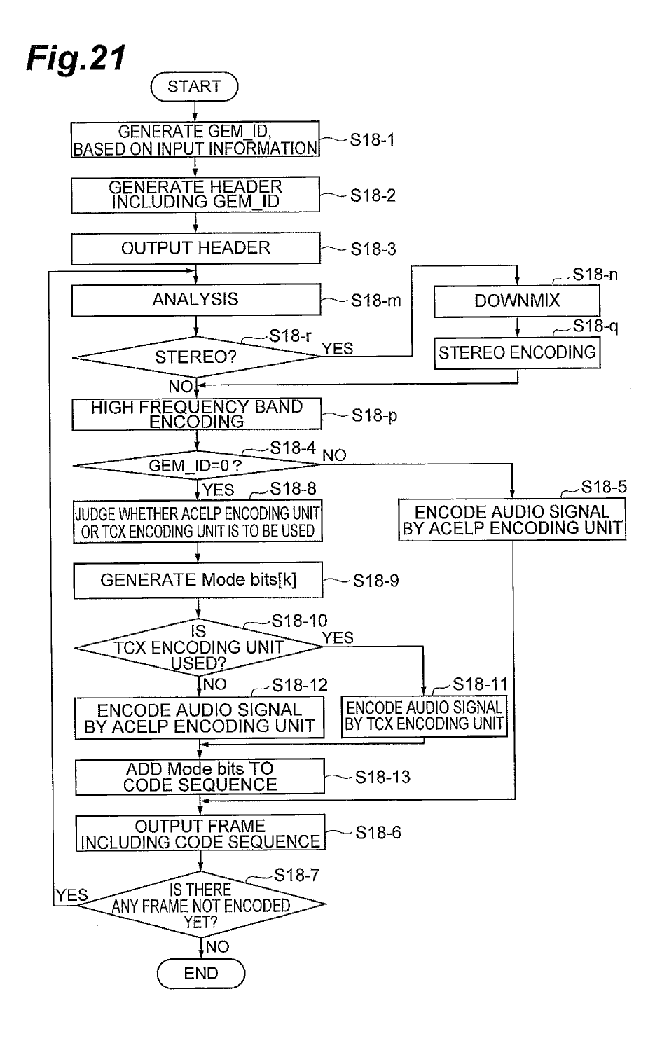

Described below is an operation of the audio encoding device 18 and an audio encoding method according to an embodiment. FIG. 21 is a flowchart of the audio encoding method according to still another embodiment.

In the embodiment, as shown in FIG. 21, step S18-1, which is equivalent to step S14-1, is carried out first. Next, in step S18-2, the header generation unit 18e generates a header of AMR-WB+ including GEM_ID, as described above. In subsequent step S18-3, the output unit 18d outputs the generated header as the head of a stream.

Next, in step S18-m, the analysis unit 18m divides an audio signal of an encoding target frame fed to the input terminal In1 into a low frequency band audio signal and a high frequency band audio signal, as described above. In step S18-m, when the audio signal fed to the input terminal In1 is a monaural audio signal, the analysis unit 18m outputs the generated low frequency band audio signal to the switch SW1 and outputs the high frequency band audio signal to the high frequency band encoding unit 18p. On the other hand, when the audio signal fed to the input terminal In1 is a stereo signal, the analysis unit 18m outputs the generated low frequency band audio signal (stereo signal) to the downmix unit 18n.

Next, when it is determined in step S18-r that the audio signal fed to the input terminal In1 is a monaural signal, the aforementioned process by the high frequency band encoding unit 18p is carried out in step S18-p, and the encoded data generated by the high frequency band encoding unit 18p is outputted from the output unit 18d. On the other hand, when the audio signal fed to the input terminal In1 is a stereo signal, the aforementioned process by the downmix unit 18n is carried out in step S18-n, the aforementioned process by the stereo encoding unit 18q is carried out in subsequent step S18-q, the encoded data generated by the stereo encoding unit 18q is outputted from the output unit 18d, and the processing proceeds to step S18-p.

Next, in step S18-4, the selection unit 18b judges whether the value of GEM_ID is “0.” When the value of GEM_ID is not “0,” i.e., when the value of GEM_ID is “1,” the selection unit 18b selects the ACELP encoding unit 18a₁. Next, in step S18-5, the ACELP encoding unit 18a₁ thus selected encodes the audio signal of the frame (low frequency band audio signal). In subsequent step S18-6, the output unit 18d outputs a frame including the generated coded sequence. When the value of GEM_ID is “1,” audio signals (low frequency band audio signals) of all frames are encoded by the ACELP encoding unit 18a₁, after it is judged in step S18-7 whether there is any frame left to be encoded, and the encoded signals are outputted.

Returning to step S18-4, when the value of GEM_ID is “0,” subsequent step S18-8 is carried out in which the encoding scheme judgment unit 18f judges whether an encoding target frame, i.e., an audio signal of each frame in the super-frame (low frequency band audio signal) is to be encoded by the ACELP encoding scheme or by the TCX encoding scheme.

Next, in step S18-9, the Mode bits generation unit 18g generates Mode bits[k] having a value according to the judgment result by the encoding scheme judgment unit 18f.

Next, it is judged in step S18-10 whether the judgment result in step S18-8 indicates that the audio signal of the encoding target frame is to be encoded by the TCX encoding scheme, i.e., by the TCX encoding unit 18a₂.

When the judgment result in step S18-8 indicates that the audio signal of the encoding target frame is to be encoded by the TCX encoding unit 18a₂, subsequent step S18-11 is carried out in which the TCX encoding unit 18a₂ encodes the audio signal (low frequency band audio signal) of the frame. On the other hand, when the judgment result does not indicate that the audio signal of the encoding target frame is to be encoded by the TCX encoding unit 18a₂, subsequent step S18-12 is carried out in which the ACELP encoding unit 18a₁ encodes the audio signal (low frequency band audio signal) of the frame. The processes from step S18-10 to step S18-12 are carried out for each of frames in the super-frame.

Next, in step S18-13, the output unit 18d adds Mode bits[k] to the coded sequence generated in step S18-11 or in step S18-12. Then the process proceeds to step S18-6.

In the audio encoding device 18 and the audio encoding method described above, GEM_ID set to “1” is also included in the header, whereby the decoder side is notified that audio signals of multiple frames were encoded only by the ACELP encoding unit. Therefore, the stream is generated in a smaller size.

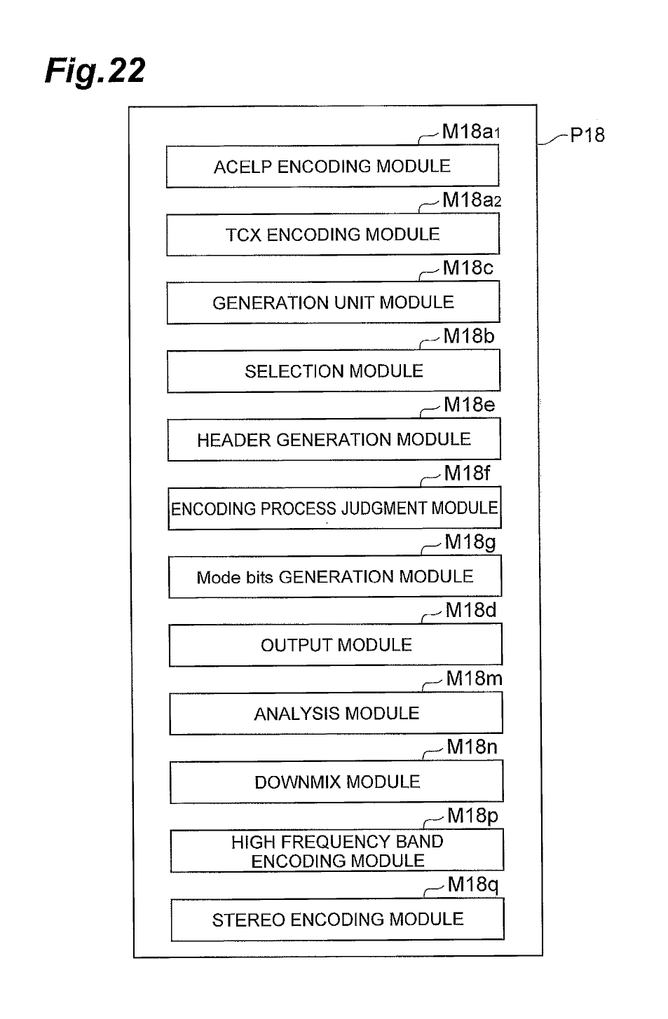

Described below is an audio encoding program for causing a computer to operate as the audio encoding device 18. FIG. 22 shows an audio encoding program according to another embodiment.

The audio encoding program P18 shown in FIG. 22 may be executed in the computer shown in FIGS. 5 and 6. Furthermore, the audio encoding program P18 may be provided in the same manner as the audio encoding program P10.

The audio encoding program P18 is comprised of an ACELP encoding module M18a₁, a TCX encoding module M18a₂, a selection module M18b, a generation module M18c, an output module M18d, a header generation module M18e, an encoding scheme judgment module M18f, a Mode bits generation module M18g, an analysis module M18m, a downmix module M18n, a high frequency band encoding module M18p, and a stereo encoding module M18q.

The ACELP encoding module M18a₁, the TCX encoding module M18a₂, the selection module M18b, the generation module M18c, the output module M18d, header generation module M18e, the encoding scheme judgment module M18f, the Mode bits generation module M18g, the analysis module M18m, the downmix module M18n, the high frequency band encoding module M18p, and the stereo encoding module M18q cause the computer C10 to perform the same functions as performed by the ACELP encoding unit 18a₁, the TCX encoding unit 18a₂, the selection unit 18b, the generation unit 18c, the output unit 18d, header generation unit 18e, the encoding scheme judgment unit 18f, the Mode bits generation unit 18g, the analysis unit 18m, the downmix unit 18n, the high frequency band encoding unit 18p, and the stereo encoding unit 18q, respectively.

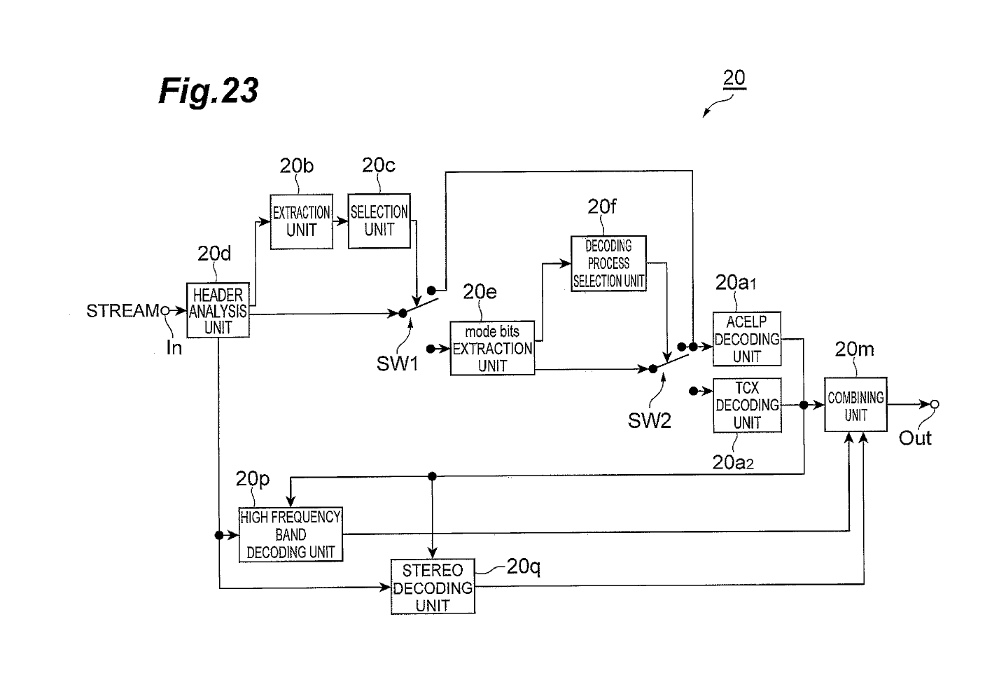

Described below is an audio decoding device that decodes a stream generated by the audio encoding device 18. FIG. 23 shows an audio decoding device according to another embodiment. The audio decoding device 20 shown in FIG. 23 is comprised of an ACELP decoding unit 20a₁ and a TCX decoding unit 20a₂. The ACELP decoding unit 20a₁ decodes a coded sequence in a frame by the ACELP decoding scheme to generate an audio signal (low frequency band audio signal). The TCX decoding unit 20a₂ decodes a coded sequence in a frame by the TCX decoding scheme to generate an audio signal (low frequency band audio signal). The audio decoding device 20 is further comprised of an extraction unit 20b, a selection unit 20c, a header analysis unit 20d, a Mode bits extraction unit 20e, a decoding scheme selection unit 20f, a high frequency band decoding unit 20p, a stereo decoding unit 20q, and a synthesis unit 20m.

The header analysis unit 20d receives the stream shown in FIG. 20 and separates the header from the stream. The header analysis unit 20d provides the separated header to the extraction unit 20b. Furthermore, the header analysis unit 20d outputs each frame in the stream from which the header is separated to a switch SW1, the high frequency band decoding unit 20p, and the stereo decoding unit 20q.

The extraction unit 20b extracts GEM_ID from the header. When the value of GEM_ID extracted is “1,” the selection unit 20c controls the switch SW1 to connect multiple frames to the ACELP decoding unit 20a₁. Thereby, coded sequences of all frames are decoded by the ACELP decoding unit 20a₁ when the value of GEM_ID is “1.”

On the other hand, when the value of GEM_ID is “0,” the selection unit 20c controls the switch SW1 to connect each frame to the Mode bits extraction unit 20e. The Mode bits extraction unit 20e extracts Mode bits[k] for each input frame, i.e., each frame in a super-frame and provides it to the decoding scheme selection unit 20f.

The decoding scheme selection unit 20f controls a switch SW2 according to the value of Mode bits[k]. Specifically, when the decoding scheme selection unit 20f determines from the value of Mode bits[k] that the ACELP decoding scheme is to be selected, it controls the switch SW2 to connect the decoding target frame to the ACELP decoding unit 20a₁. On the other hand, when the decoding scheme selection unit 20f determines from the value of Mode bits[k] that the TCX decoding scheme is to be selected, it controls the switch SW2 to connect the decoding target frame to the TCX decoding unit 20a₂.

The high frequency band decoding unit 20p decodes the encoded data included in the decoding target frame to restore the aforementioned parameter. The high frequency band decoding unit 20p generates the high frequency band audio signal, using the restored parameter and the low frequency band audio signal decoded by the ACELP decoding unit 20a₁ and/or by the TCX decoding unit 20a₂, and outputs the high frequency band audio signal to the synthesis unit 20m.

The stereo decoding unit 20q decodes the encoded data included in the decoding target frame to restore the aforementioned parameter, the balance factor, and the waveform of the side signal. The stereo decoding unit 20q generates a stereo signal, using the restored parameter, balance factor, and waveform of the side signal, and the low frequency band monaural audio signal decoded by the ACELP decoding unit 20a₁ and/or by the TCX decoding unit 20a₂.

The synthesis unit 20m combines the low frequency band audio signal restored by the ACELP decoding unit 20a₁ and/or by the TCX decoding unit 20a₂ with the high frequency band audio signal generated by the high frequency band decoding unit 20p in order to generate a decoded audio signal. When a stereo signal is a target signal to be processed, the synthesis unit 20m generates a stereo audio signal, also using the input signal (stereo signal) from the stereo decoding unit 20q.

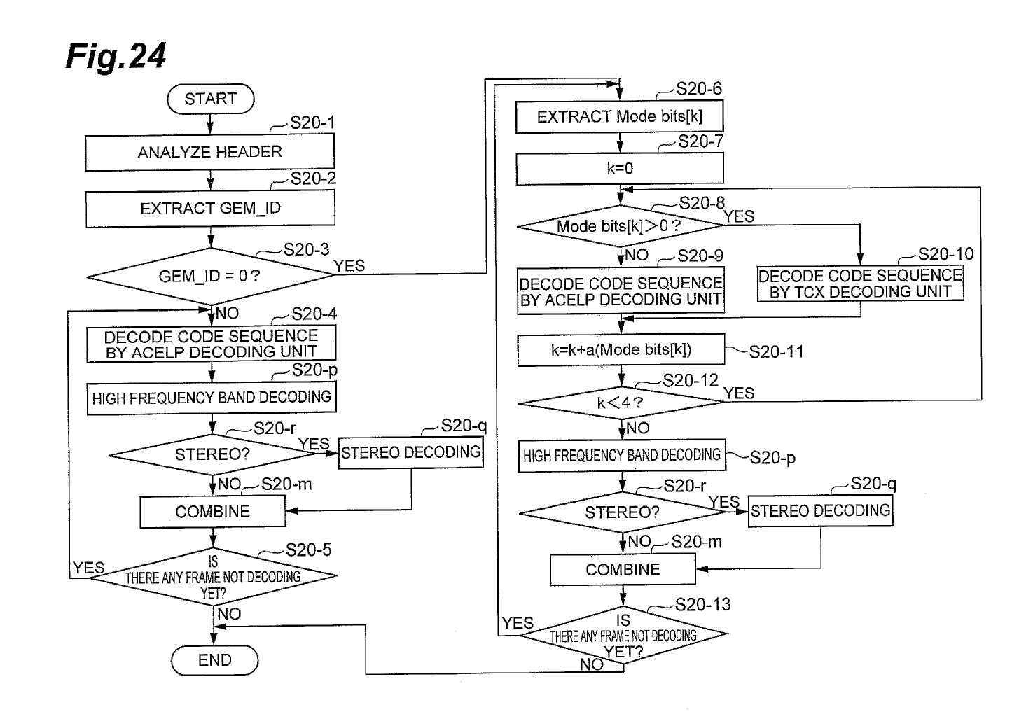

Described below is an operation of the audio decoding device 20 and an audio decoding method according to an embodiment. FIG. 24 is a flowchart of the audio decoding method according to another embodiment.

In an embodiment, as shown in FIG. 24, step S20-1 is carried out first in which the header analysis unit 20d separates a header from a stream.

Next, in step S20-2, the extraction unit 20b extracts GEM_ID from the header. In subsequent step S20-3, the selection unit 20c controls a switch SW1 according to the value of GEM_ID.

Specifically, when the value of GEM_ID is “1,” the selection unit 20c controls the switch SW1 to select the ACELP decoding unit 20a₁ as a decoding unit to decode coded sequences of multiple frames in the stream. In this case, in subsequent step S20-4, the ACELP decoding unit 20a₁ decodes a coded sequence of a decoding target frame. Thereby, a low frequency band audio signal is restored.

Next, in step S20-p, the high frequency band decoding unit 20p restores a parameter from the encoded data included in the decoding target frame. In step S20-p, the high frequency band decoding unit 20p generates a high frequency band audio signal, using the restored parameter and the low frequency band audio signal restored by the ACELP decoding unit 20a₁, and outputs the high frequency band audio signal to the synthesis unit 20m.

Next, when it is determined in step S20-r that a stereo signal is a target signal to be processed, subsequent step S20-q is carried out in which the stereo decoding unit 20q decodes the encoded data included in the decoding target frame to restore the aforementioned parameter, the balance factor, and the waveform of the side signal. In step S20-q, the stereo decoding unit 20q restores a stereo signal, using the restored parameter, balance factor, and waveform of the side signal, and the low frequency band monaural audio signal restored by the ACELP decoding unit 20a₁.

Next, in step S20-m, the synthesis unit 20m combines the low frequency band audio signal restored by the ACELP decoding unit 20a₁ and the high frequency band audio signal generated by the high frequency band decoding unit 20p to generate a decoded audio signal. When a stereo signal is a target signal to be processed, the synthesis unit 20m restores a stereo audio signal, also using the input signal (stereo signal) from the stereo decoding unit 20q.

When it is judged in step S20-5 that there is no frame left to be decoded, the process ends. On the other hand, when there is a frame left to be decoded, the processes from step S20-4 are repeated for a target unprocessed frame.

Returning to step S20-3, when the value of GEM_ID is “0,” the selection unit 20c controls the switch SW1 to connect each frame in the stream to the Mode bits extraction unit 20e. In this case, in subsequent step S20-6, the Mode bits extraction unit 20e extracts Mode bits[k] from the decoding target super-frame. Mode bits[k] may be extracted from the super-frame at once or may be extracted one at a time in its order during decoding of each frame in the super-frame.

Next, in step S20-7, the decoding scheme selection unit 20f sets the value of k to “0.” In subsequent step S20-8, the decoding scheme selection unit 20f judges whether the value of Mode bits[k] is larger than 0. When the value of Mode bits[k] is not larger than 0, subsequent step S20-9 is carried out in which the ACELP decoding unit 20a₁ decodes a coded sequence of a decoding target frame in the super-frame. On the other hand, when the value of Mode bits[k] is larger than 0, the TCX decoding unit 20a₂ decodes the coded sequence of the decoding target frame in the super-frame.

Next, in step S20-11, the decoding scheme selection unit 20f updates the value of k to k+a(Mode bits[k]). The relationship between the values of Mode bits[k] and a(Mode bits[k]) herein may be equivalent to the relation between mod[k] and a(mod[k]) shown in FIG. 17.

Next, in step S20-12, the decoding scheme selection unit 20f judges whether the value of k is smaller than 4. When the value of k is smaller than 4, the processes from step S20-8 are continued for a target subsequent frame in the super-frame. On the other hand, when the value of k is not less than 4, step S20-p is carried out in which the high frequency band decoding unit 20p restores the parameter from the encoded data included in the decoding target frame. In step S20-p, the high frequency band decoding unit 20p generates a high frequency band audio signal from the parameter and the low frequency band audio signal restored by the decoding unit 20a₁ or by the decoding unit 20a₂, and outputs the high frequency band audio signal to the synthesis unit 20m.

Next, when it is determined in step S20-r that a stereo signal is a target signal to be processed, subsequent step S20-q is carried out in which the stereo decoding unit 20q decodes the encoded data included in the decoding target frame to restore the aforementioned parameter, the balance factor, and the waveform of the side signal. In step S20-q, the stereo decoding unit 20q restores a stereo signal, using the restored parameter, balance factor, and waveform of the side signal, and the low frequency band monaural audio signal restored by the decoding unit 20a₁ or by the decoding unit 20a₂.

Next, in step S20-m, the synthesis unit 20m synthesizes a decoded audio signal from the low frequency band audio signal restored by the decoding unit 20a₁ or by the decoding unit 20a₂, and the high frequency band audio signal generated by the high frequency band decoding unit 20p. When a stereo signal is a target signal to be processed, the synthesis unit 20m restores a stereo audio signal, also using an input signal (stereo signal) from the stereo decoding unit 20q. Then the process proceeds to step S20-13.

It is judged in step S20-13 whether there is any frame let to be decoded. When there is no frame left to be decoded, the process is terminated. On the other hand, when there is a frame let to be decoded, the processes from step S20-6 are executed for a target frame (super-frame).

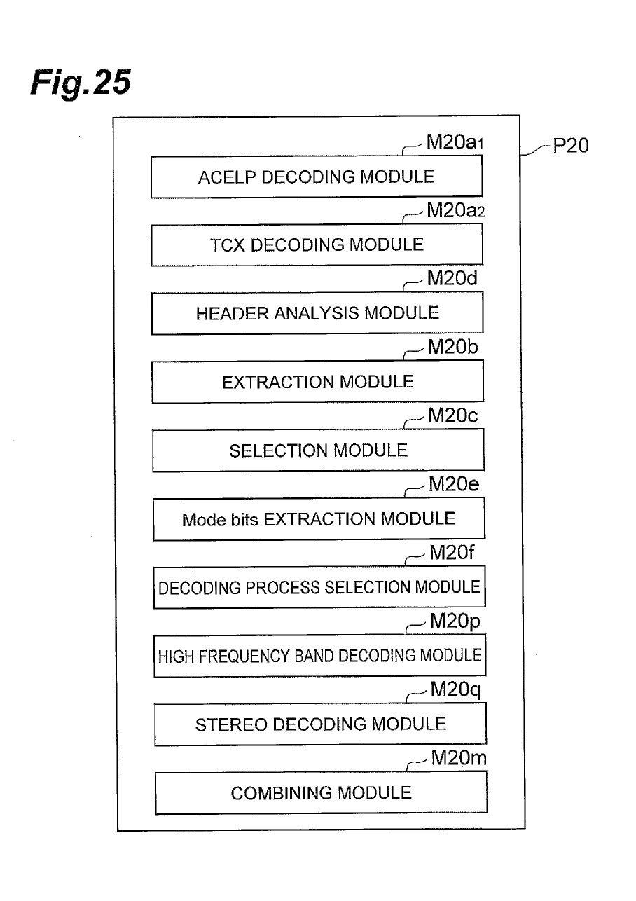

Described below is an audio decoding program that causes a computer to operate as the audio decoding device 20. FIG. 25 shows an audio decoding program according to another embodiment.

The audio decoding program P20 shown in FIG. 25 may be executed in the computer shown in FIGS. 5 and 6. The audio decoding program P20 can be provided in the same manner as the audio encoding program P10.

The audio decoding program P20 is comprised of an ACELP decoding module M20a₁, a TCX decoding module M20a₂, an extraction module M20b, a selection module M20c, a header analysis module M20d, a Mode bits extraction module M20e, a decoding scheme selection module M20f, a high frequency band decoding module M20p, a stereo decoding module M20q, and a synthesis module M20m.

The ACELP decoding module M20a₁, the TCX decoding module M20a₂, the extraction module M20b, the selection module M20c, the header analysis module M20d, the Mode bits extraction module M20e, the decoding scheme selection module M20f, the high frequency band decoding module M20p, the stereo decoding module M20q, and the synthesis module M20m cause the computer to perform the same functions as performed by the ACELP decoding unit 20a₁, the TCX decoding unit 20a₂, the extraction unit 20b, the selection unit 20c, the header analysis unit 20d, the Mode bits extraction unit 20e, the decoding scheme selection unit 20f, the high frequency band decoding unit 20p, the stereo decoding unit 20q, and the synthesis unit 20m, respectively.

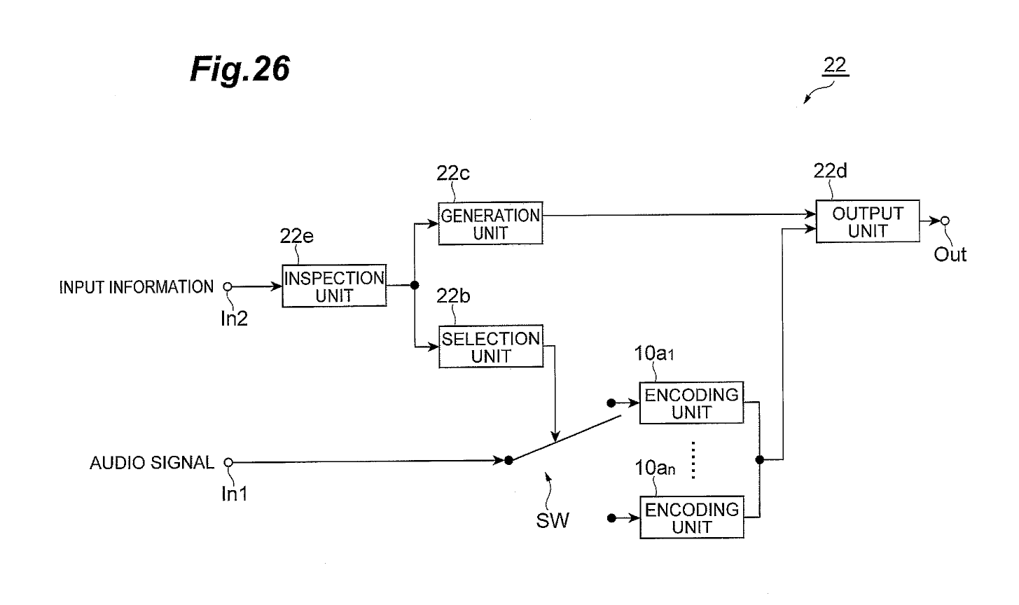

Described below is an audio encoding device of another embodiment. FIG. 26 shows an audio encoding device according to another embodiment. The audio encoding device 22 shown in FIG. 26 can implement switching between an audio encoding scheme used to encode audio signals of a first plurality of frames and an audio encoding scheme used to encode audio signals of subsequent second plurality of frames.

Like the audio encoding device 10, the audio encoding device 22 is comprised of the encoding units 10a₁-10aₙ. The audio encoding device 22 is further comprised of a generation unit 22c, a selection unit 22b, an output unit 22d, and an inspection unit 22e.

The inspection unit 22e monitors an input inputted in the input terminal In2 and receives input information fed to the input terminal In2. The input information is information for specifying an audio encoding scheme used commonly to encode multiple frames.

The selection unit 22b selects an encoding unit according to the input information. Specifically, the selection unit 22b controls a switch SW to connect an audio signal fed to the input terminal In1 to an encoding unit to execute the audio encoding scheme specified by the input information. The selection unit 22b continues selection of a single encoding unit until next input information is fed to the inspection unit 22e.

Every time the inspection unit 22e receives input information, the generation unit 22c generates, based on the input information, the long-term encoding scheme information which indicates that a common encoding scheme was used for multiple frames.

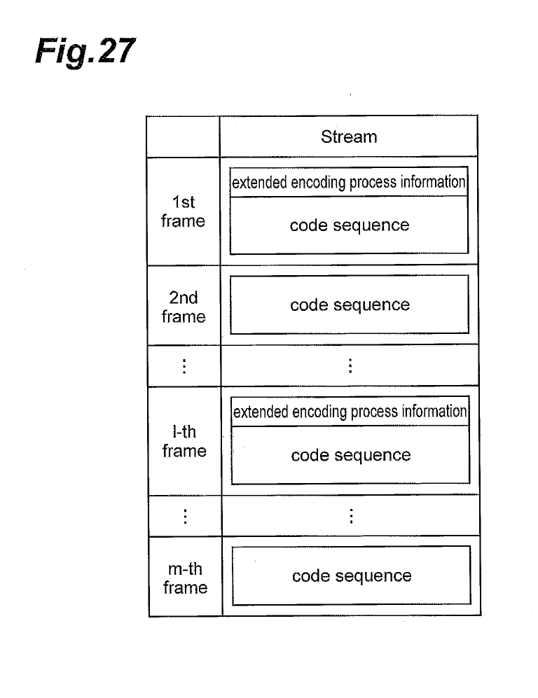

When the generation unit 22c generates the long-term encoding scheme information, the output unit 22d adds the long-term encoding scheme information to multiple frames. FIG. 27 shows a stream generated by the audio encoding device shown in FIG. 26. As shown in FIG. 27, the long-term encoding scheme information is added to a lead frame of the multiple frames. In the example shown in FIG. 27, the multiple frames consisting of the first frame to the (l−1)th frame are encoded by a common encoding scheme, the encoding scheme is switched to another at the l-th frame, and the multiple frames from the l-th frame to the m-th frame are encoded by a common encoding scheme.

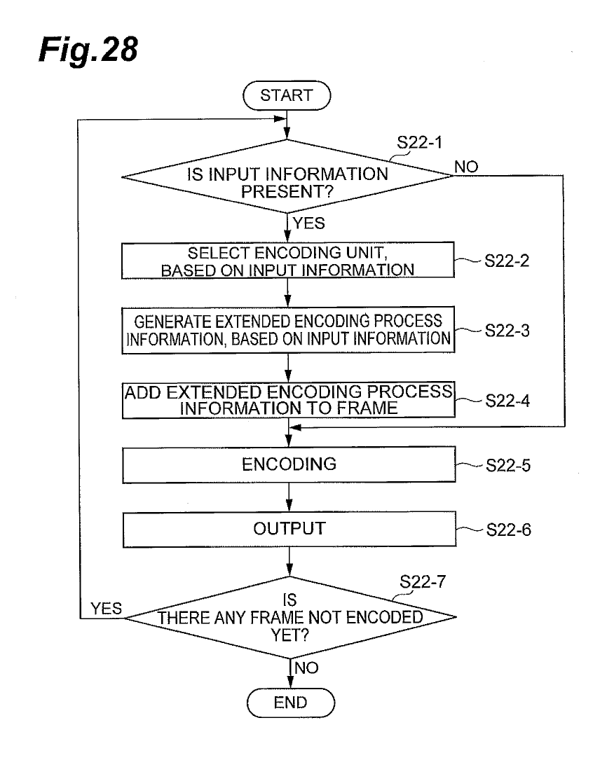

Described below is an operation of the audio encoding device 22 and an audio encoding method according to an embodiment. FIG. 28 is a flowchart showing an audio encoding method according to another embodiment.

In the embodiment, as shown in FIG. 28, in step S22-1, the inspection unit 22e monitors inputted input information. When the input information is received, step S22-2 is carried out in which the selection unit 22b selects an encoding unit according to the input information.

Next, in step S22-3, the selection unit 22b generates the long-term encoding scheme information, based on the input information. The long-term encoding scheme information may be added to a lead frame of the multiple frames by the output unit 22d in step S22-4.

In step S22-5, an audio signal of an encoding target frame is then encoded by the selected encoding unit. Until next input information is fed, the audio signal of the encoding target frame is encoded without passing through the processes of steps S22-2 to S22-4.

Next, in step S22-6, the encoded coded sequence is added in a frame in a bit stream corresponding to the encoding target frame and is outputted from the output unit 22d.

Next, it is judged in step S22-7 whether there is any frame left to be encoded. When there is no frame left uncoded, the process ends. On the other hand, when there is a frame left to be encoded, the processes from step S22-1 are performed.

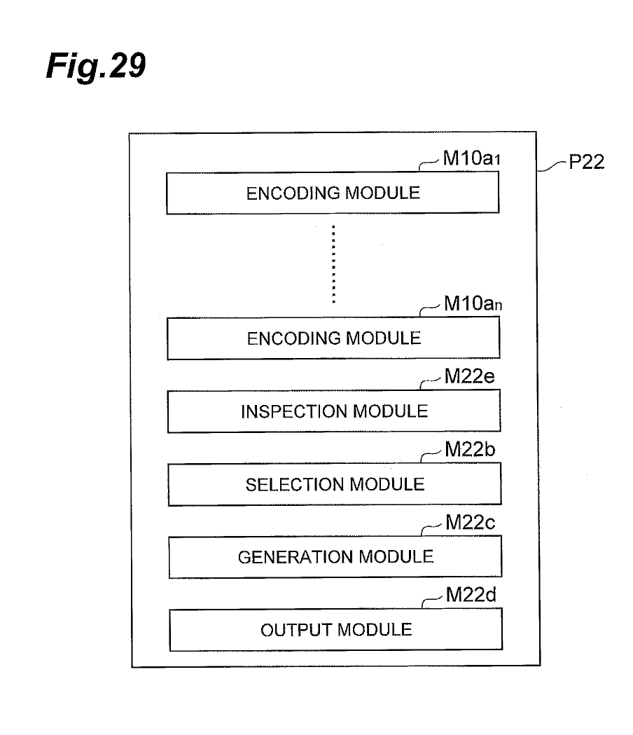

Described below is an audio encoding program that cause a computer to operate as the audio encoding device 22. FIG. 29 shows an audio encoding program according to another embodiment.

The audio encoding program P22 shown in FIG. 29 may be executed in the computer shown in FIGS. 5 and 6. The audio encoding program P22 can be provided in the same manner as the audio encoding program P10.

As shown in FIG. 29, the audio encoding program P22 is comprised of encoding modules M10a₁-10aₙ, a generation module M22c, a selection module M22b, an output module M22d, and an inspection module M22e.

The encoding modules M10a₁-10aₙ, the generation module M22c, the selection module M22b, the output module M22d, and the inspection module M22e cause the computer C10 to perform the same functions as performed by the encoding units 10a₁-10aₙ, the generation unit 22c, the selection unit 22b, the output unit 22d, and the inspection unit 22e, respectively.

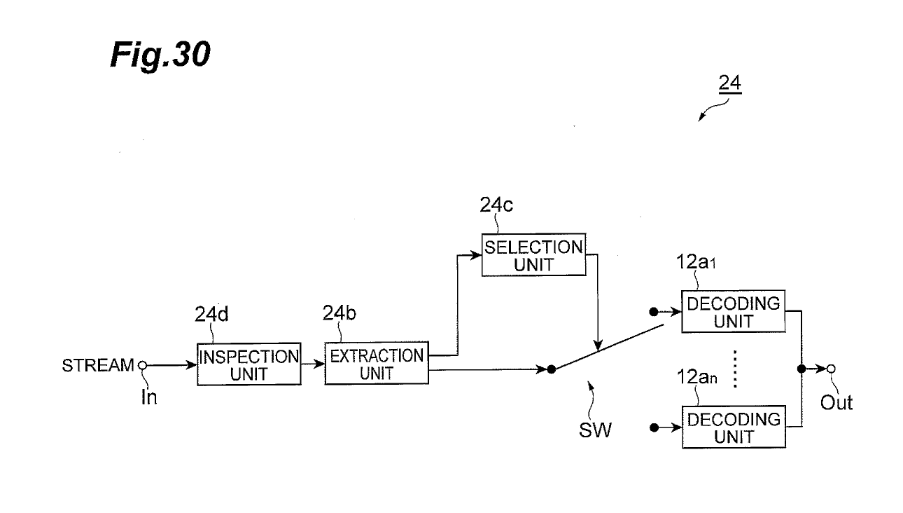

Described below is an audio decoding device that decodes a stream generated by the audio encoding device 22. FIG. 30 shows an audio decoding device according to another embodiment.

Like the audio decoding device 12, an audio decoding device 24 shown in FIG. 30 is comprised of the decoding units 12a₁-12aₙ. The audio decoding device 24 is further comprised of an extraction unit 24b, a selection unit 24c, and an inspection unit 24d.

The inspection unit 24d determines whether the long-term encoding scheme information is included in each frame in a stream fed to the input terminal In. When the inspection unit 24d determines that the long-term encoding scheme information is included in a frame, the extraction unit 24b extracts the long-term encoding scheme information from the frame. The extraction unit 24b sends the frame to a switch SW after the long-term encoding scheme information is extracted.

When the extraction unit 24b extracts the long-term encoding scheme information, the selection unit 24c controls the switch SW, based on the long-term encoding scheme information, to select a decoding unit to execute an audio decoding scheme corresponding to an encoding scheme specified. Until the inspection unit 24d extracts next long-term encoding scheme information, the selection unit 24c continues selecting a single decoding unit and continues decoding coded sequences of multiple frames by a common audio decoding scheme.

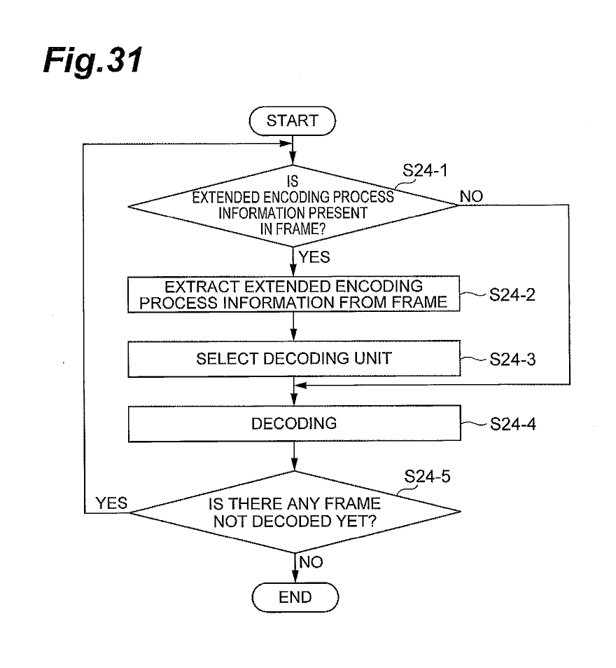

Described below is an operation of the audio decoding device 24 and an audio decoding method according to an embodiment. FIG. 31 is a flowchart showing the audio decoding method according to another embodiment.

In the embodiment as shown in FIG. 31, in step S24-1, the inspection unit 24d monitors whether long-term encoding scheme information is included in an input frame. When the inspection unit 24d detects the long-term encoding scheme information, subsequent step S24-2 is carried out in which the extraction unit 24b extracts the long-term encoding scheme information from the frame.

Next, in step S24-3, the selection unit 24c selects an appropriate decoding unit, based on the long-term encoding scheme information extracted. In subsequent step S24-4, the selected decoding unit decodes a coded sequence of a decoding target frame.

It is then judged in step S24-5 whether there is any frame left to be decoded. When there is no frame left to be decoded, the process ends. On the other hand, when there is a frame left to be decoded, the processes from step S24-1 are executed.

In the present embodiment, when it is determined in step S24-1 that the long-term encoding scheme information is not added to the frame, the process of step S24-4 is executed without passing through the processes of step S24-2 and step S24-3.

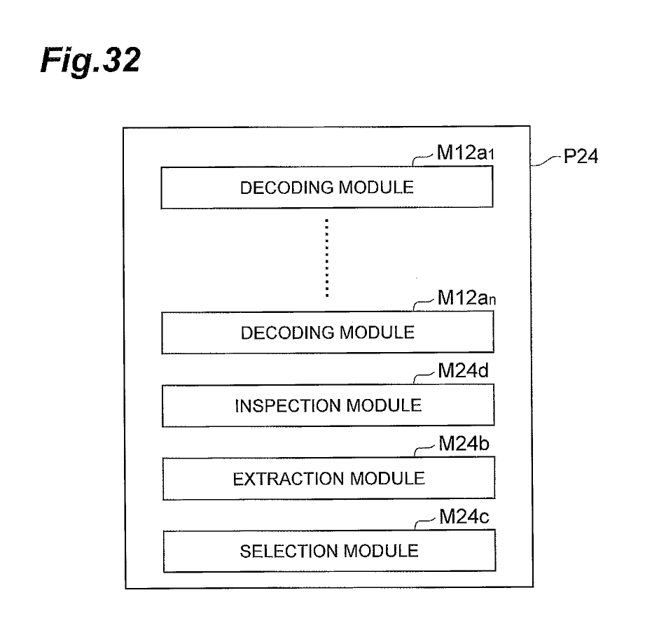

Described below is an audio decoding program that causes a computer to operate as the audio decoding device 24. FIG. 32 shows an audio decoding program according to another embodiment.

The audio decoding program P24 shown in FIG. 32 may be executed in the computer shown in FIGS. 5 and 6. The audio decoding program P24 can be provided in the same manner as the audio encoding program P10.

As shown in FIG. 32, the audio decoding program P24 is comprised of the decoding modules M12a₁-12aₙ, an extraction module M24b, a selection module M24c, and an inspection module M24d.

The decoding modules M12a₁-12aₙ, the extraction module M24b, the selection module M24c, and the inspection module M24d cause the computer C10 to perform the same functions as performed by the decoding units 12a₁-12aₙ, the extraction unit 24b, the selection unit 24c, and the inspection unit 24d, respectively.

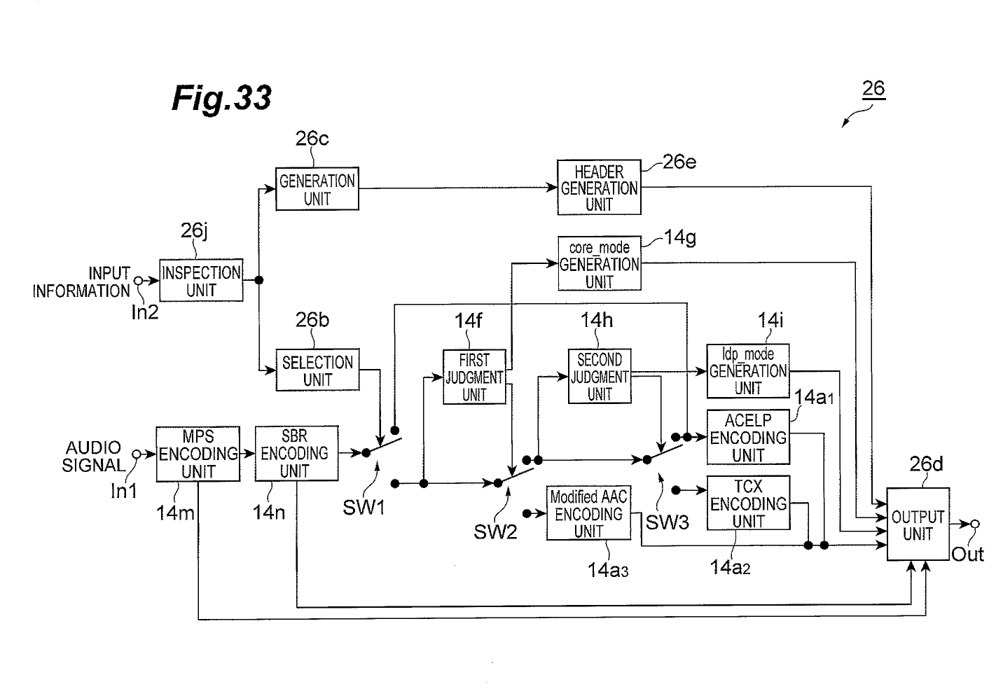

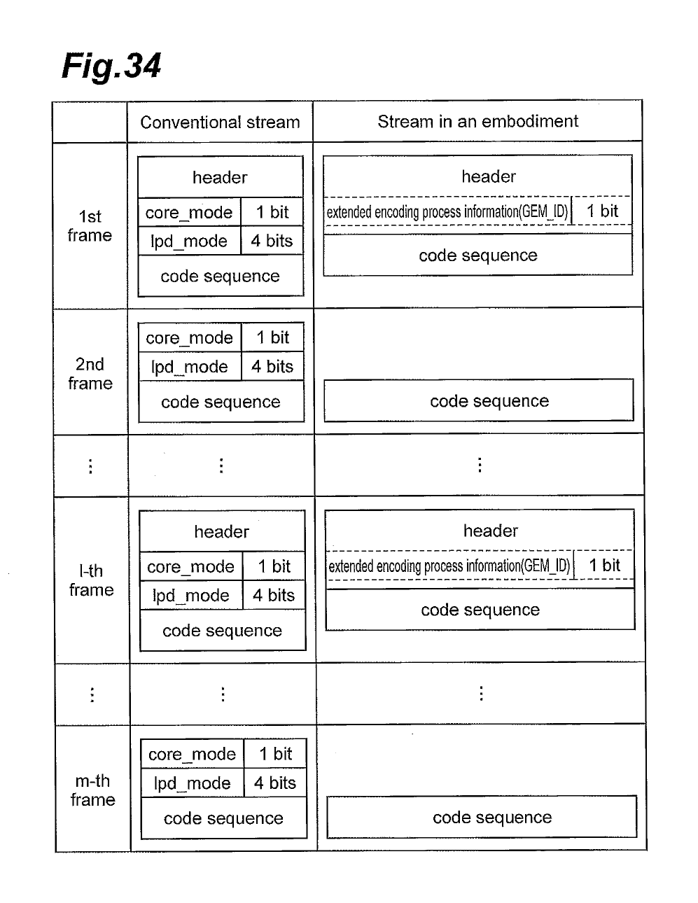

Described below is an audio encoding device according to another embodiment. FIG. 33 shows an audio encoding device according to another embodiment. FIG. 34 shows streams generated according to the conventional MPEG USAC and a stream generated by the audio encoding device shown in FIG. 33.

The aforementioned audio encoding device 14 can either encode audio signals of all frames by a single common audio encoding scheme or encode an audio signal of each frame by a respective audio encoding scheme.

On the other hand, the audio encoding device 26 shown in FIG. 33 uses a common audio encoding scheme for some frames of the multiple frames. The audio encoding device 26 also uses respective audio encoding schemes for some frames of the frames. Furthermore, the audio encoding device 26 uses a common audio encoding scheme for multiple frames coming amid all the frames.

As shown in FIG. 33, like the audio encoding device 14, the audio encoding device 26 is comprised of the ACELP encoding unit 14a₁, the TCX encoding unit 14a₂, the Modified AAC encoding unit 14a₃, the first judgment unit 14f, the core_mode generation unit 14g, the second judgment unit 14h, the lpd_mode generation unit 14i, the MPS encoding unit 14m, and the SBR encoding unit 14n. The audio encoding device 26 is further comprised of an inspection unit 26j, a selection unit 26b, a generation unit 26c, an output unit 26d, and a header generation unit 26e. Among the elements of the audio encoding device 26, elements different from those of the audio encoding device 14 will be described below.

The inspection unit 26j inspects whether there is input information fed to the input terminal In2. The input information is information indicating whether audio signals of multiple frames are to be encoded by a common audio encoding scheme.

When the inspection unit 26j detects the input information, the selection unit 26b controls a switch SW1. Specifically, when the detected input information indicates that audio signals of multiple frames are to be encoded by a common audio encoding scheme, the selection unit 26b controls the switch SW1 to connect the switch SW1 to the ACELP encoding unit 14a₁. On the other hand, when the detected input information indicates that audio signals of multiple frames are not to be encoded by a common audio encoding scheme, the selection unit 26b controls the switch SW1 to connect the switch SW1 to a path leading to the first judgment unit 14f and others.

When the inspection unit 26j detects the input information, the generation unit 26c generates GEM_ID for an output frame corresponding to an encoding target frame found at that point. Specifically, when the detected input information indicates that audio signals of multiple frames are to be encoded by a common audio encoding scheme, the generation unit 26c sets the value of GEM_ID to “1.” On the other hand, when the detected input information indicates that audio signals of multiple frames are not to be encoded by a common audio encoding scheme, the generation unit 26c sets the value of GEM_ID to “0.”

When the inspection unit 26j detects the input information, the header generation unit 26e generates a header of an output frame corresponding to an encoding target frame found at that point and adds GEM_ID generated by the generation unit 26c in the header.

The output unit 26d outputs an output frame including a generated coded sequence. Furthermore, the output unit 26d adds in each output frame encoded data of a parameter generated by the MPS encoding unit 14m and encoded data of a parameter generated by the SBR encoding unit 14n. When the input information is detected by the inspection unit 26j, the output frame contains the header generated by the header generation unit 26e.

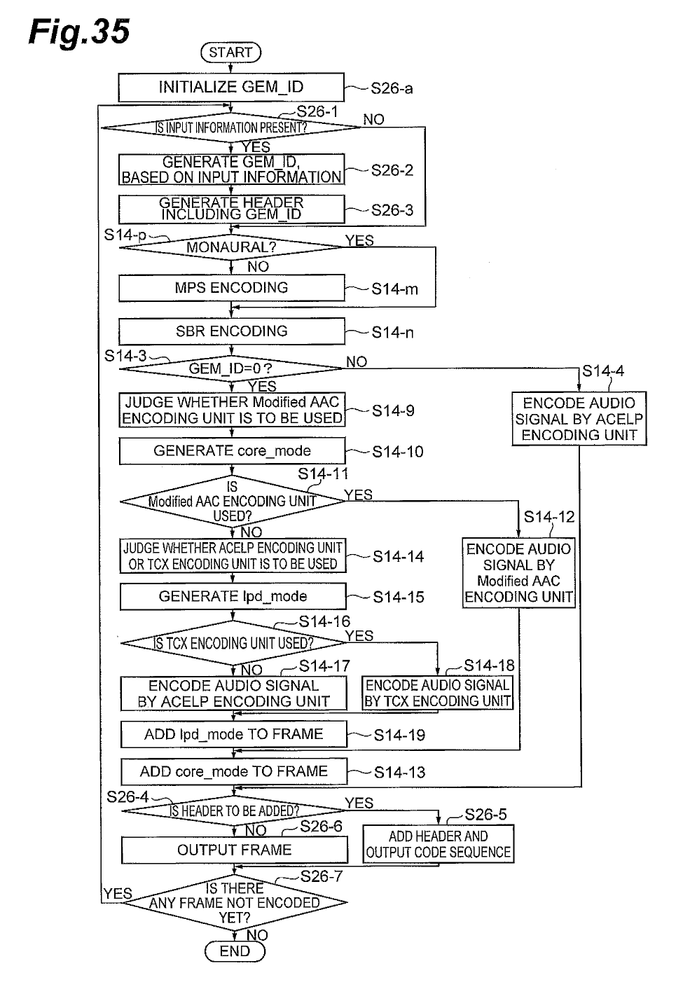

Described below are an operation of the audio encoding device 26 and an audio encoding method according to another embodiment. FIG. 35 is a flowchart showing an audio encoding method according to another embodiment.

In the flow shown in FIG. 35, the processes of steps S14-3 to 4, steps S14-9 to 19, and step S14-m to step S14-n are the same as those shown in FIG. 13. The processes different from those in the flow shown in FIG. 13 will be described below.

In the embodiment as shown in FIG. 35, in step S26-a, the value of GEM_ID is initialized. The value of GEM_ID may be initialized, for example, to “0.” In step S26-1, the inspection unit 26j monitors the input information as described above. When an input of the input information is detected, subsequent step S26-2 is carried out in which the generation unit 26c generates GEM_ID according to the input information, and thereafter step S26-3 is carried out in which the header generation unit 26e generates a header including GEM_ID thus generated. On the other hand, when there is no input information detected, the process proceeds to step S14-p, without passing through the processes of steps S26-2 and S26-3.

In step S26-4, it is determined whether a header is to be added. When the inspection unit 26j detects the input information, a header including GEM_ID is added in step S26-5 to an output frame corresponding to an encoding target frame found at that point, and the frame including the header is outputted. On the other hand, when no input information is detected, an output frame corresponding to an encoding target frame found at that point is outputted as it is in step S26-6.

It is then judged in step S26-7 whether there is any frame left to be encoded. When there is no frame left uncoded, the process ends. On the other hand, when there is a frame left to be encoded, the processes from step S26-1 are executed for a target frame left to be encoded.

According to the audio encoding device 26 and the audio encoding method of the embodiment described above, multiple frames are encoded by a common audio encoding scheme, some frames thereafter are encoded by respective audio encoding schemes, and multiple frames subsequent thereto are encoded by a common audio encoding scheme.

The audio encoding device 26 determines an audio encoding scheme to be used to encode audio signals of multiple frames, based on the input information. However, in the present invention, an audio encoding scheme to be used commonly for multiple frames may be determined based on the result of an analysis on an audio signal of each frame. For example, an analysis unit to analyze an audio signal of each frame is provided between the input terminal In1 and the switch SW1 and, the selection unit 26b and the generation unit 26c, and others may be made to operate based on the analysis result. The aforementioned analysis technique may be applied to this analysis.

It should be noted that audio signals of all frames may be connected to the path including the first judgment unit 14f and output frames including coded sequences may be stored in the output unit 26d. In this case, using the judgment results by the first judgment unit 14f and the second judgment unit 14h, operations, such setting of lpd_mode, core_mode, and so on, and generation and addition of the header, may be performed ex-post for each frame.

It should be noted that after an analysis is performed on a predetermined number of frames, or judgments are performed on the predetermined number of frames by the first judgment unit 14f and the second judgment unit, an encoding scheme commonly to be used for multiple frames including the predetermined number of frames may be predicted, using the analysis result or the judgment results on the predetermined number of frames.

Whether a common encoding scheme or respective encoding schemes are executed for multiple frames may be determined so as to reduce an amount of additional information including core_mode, lpd_mode, and the header or the like.

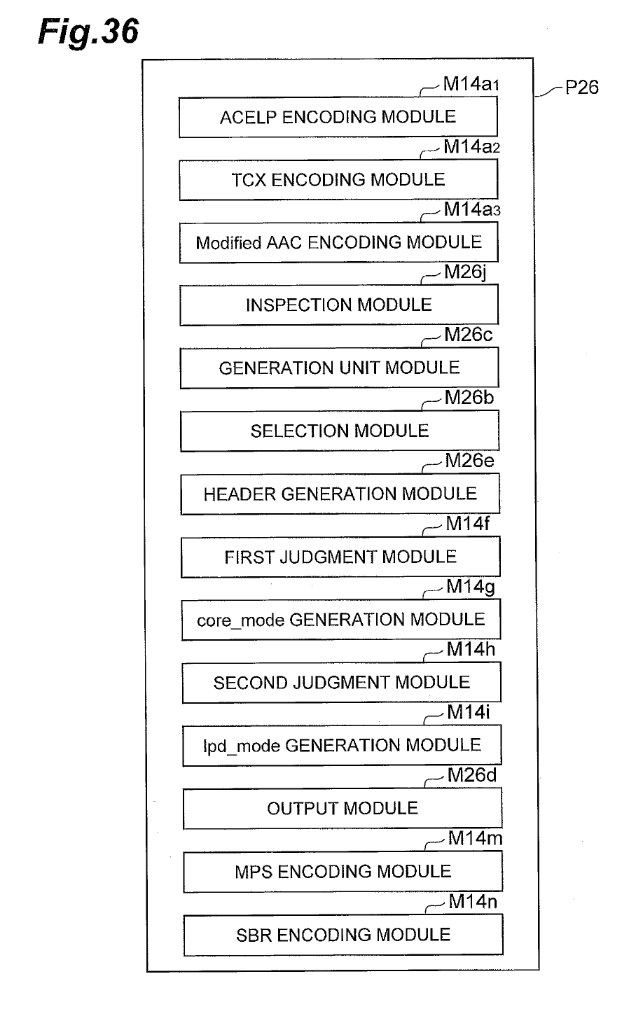

Described below is an audio encoding program that cause a computer to operate as the audio encoding device 26. FIG. 36 shows an audio encoding program according to another embodiment.

The audio encoding program P26 shown in FIG. 36 may be executed in the computer shown in FIGS. 5 and 6. The audio encoding program P26 can be provided in the same manner as the audio encoding program P10.

As shown in FIG. 36, the audio encoding program P26 is comprised of the ACELP encoding module M14a₁, the TCX encoding module M14a₂, the Modified AAC encoding module M14a₃, the first judgment module M14f, the core_mode generation module M14g, the second judgment module M14h, the lpd_mode generation module M14i, the MPS encoding module M14m, the SBR encoding module M14n, an inspection module M26j, a selection module M26b, a generation module M26c, an output module M26d, and a header generation module M26e.

The ACELP encoding module M14a₁, the TCX encoding module M14a₂, the Modified AAC encoding module M14a₃, the first judgment module M14f, the core_mode generation module M14g, the second judgment module M14h, the lpd_mode generation module M14i, the MPS encoding module M14m, the SBR encoding module M14n, the inspection module M26j, the selection module M26b, the generation module M26c, the output module M26d, and the header generation module M26e cause the computer C10 to perform the same functions as performed by the ACELP encoding unit 14a₁, the TCX encoding unit 14a₂, the Modified AAC encoding unit 14a₃, the first judgment unit 14f, the core_mode generation unit 14g, the second judgment unit 14h, the lpd_mode generation unit 14i, the MPS encoding unit 14m, the SBR encoding unit 14n, the inspection unit 26j, the selection unit 26b, the generation unit 26c, the output unit 26d, and the header generation unit 26e, respectively.

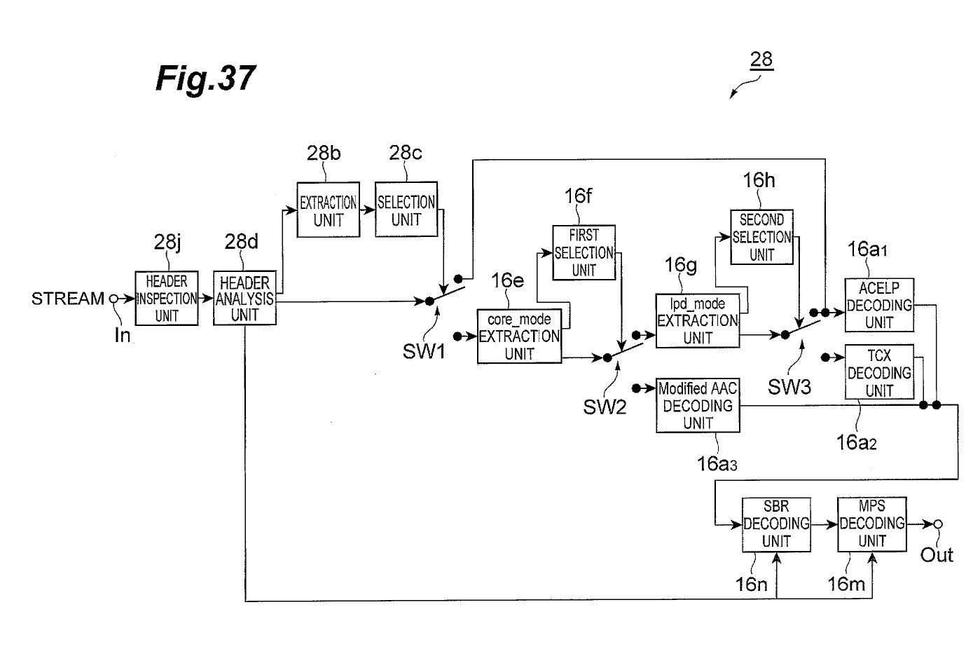

Described below is an audio decoding device that decodes a stream generated by the audio encoding device 26. FIG. 37 shows an audio decoding device according to another embodiment.

Like the audio decoding device 16, the audio decoding device 28 shown in FIG. 37 is comprised of the ACELP decoding unit 16a₁, the TCX decoding unit 16a₂, the Modified AAC decoding unit 16a₃, the core_mode extraction unit 16e, the first selection unit 16f, the lpd_mode extraction unit 16g, the second selection unit 16h, the MPS decoding unit 16m, and the SBR decoding unit 16n. The audio decoding device 28 is further comprised of a header inspection unit 28j, a header analysis unit 28d, an extraction unit 28b, and a selection unit 28c. Among the elements of the audio decoding device 28, elements different from those of the audio decoding device 16 will be described below.

The header inspection unit 28j monitors whether there is a header in each frame fed to the input terminal In. When the header inspection unit 28j detects that there is a header in a frame, the header analysis unit 28d separates the header. The extraction unit 28b extracts GEM_ID from the extracted header.

The selection unit 28c controls a switch SW1 according to extracted GEM_ID. Specifically, when the value of GEM_ID is “1,” the selection unit 28c controls the switch SW1 to connect the frame sent from the header analysis unit 28d, to the ACELP decoding unit 16a₁ until next GEM_ID is extracted.

On the other hand, when the value of GEM_ID is “0,” the selection unit 28c connects the frame sent from the header analysis unit 28d to the core_mode extraction unit 16e.

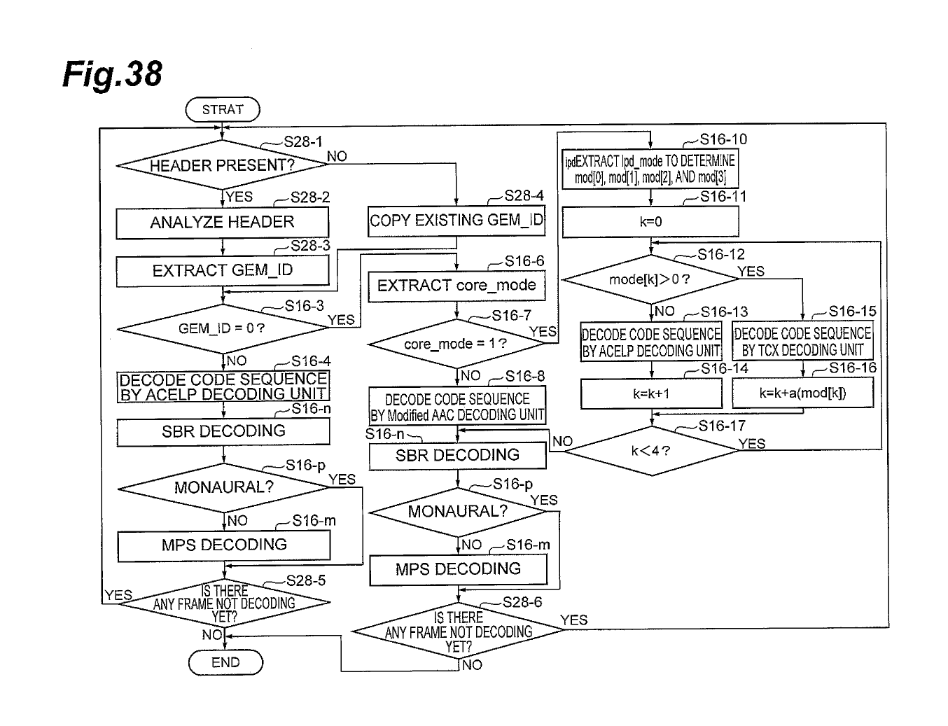

Described below is operations of the audio decoding device 28 and an audio decoding method according to another embodiment. FIG. 38 is a flowchart showing an audio decoding method according to another embodiment.

The processes specified by reference signs including “S16” in FIG. 38 are the same processes as the corresponding processes found in FIG. 16. Among the processes in FIG. 38, processes different from those shown in FIG. 16 will be described below.

In the embodiment as shown in FIG. 38, in step S28-1, the header inspection unit 28j monitors whether there is a header included in an input frame. When a header is included in a frame, subsequent step S28-2 is carried out in which the header analysis unit 28d separates the header from the frame. In step S28-3, the extraction unit 28b then extracts GEM_ID from the header. On the other hand, when there is no header found in the frame, step S28-4 is carried in which GEM_ID extracted immediately before is copied, and copied GEM_ID is used thereafter.

It is judged in step S28-5 whether there is any frame left to be decoded. When there is no frame left to be decoded, the process ends. On the other hand, when there is a frame left to be decoded, the processes from step S28-1 are executed for a target frame left to be decoded.

It is judged in step S28-6 whether there is any frame left to be decoded. When there is no frame left to be decoded, the process ends. On the other hand, when there is a frame left to be decoded, the processes from step S28-1 are executed for a target frame left to be decoded.

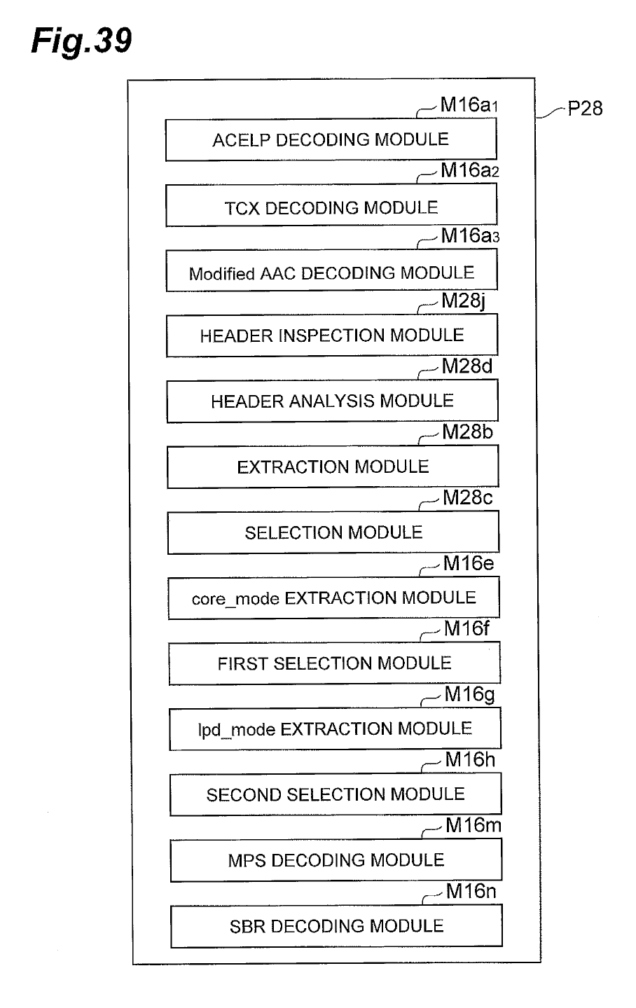

Described below is an audio decoding program that causes a computer to operate as the audio decoding device 28. FIG. 39 shows an audio decoding program according to another embodiment.

An audio decoding program P28 shown in FIG. 39 may be executed in the computer shown in FIGS. 5 and 6. The audio decoding program P28 can be provided in the same manner as the audio encoding program P10.

As shown in FIG. 39, the audio decoding program P28 is comprised of the ACELP decoding module M16a1, the TCX decoding module M16a2, the Modified AAC decoding module M16a3, the core_mode extraction module M16e, the first selection module M16f, the lpd_mode extraction module M16g, the second selection module M16h, the MPS decoding module M16m, the SBR decoding module M16n, a header inspection module M28j, a header analysis module M28d, an extraction module M28b, and a selection module M28c.

The ACELP decoding module M16a1, the TCX decoding module M16a2, the Modified AAC decoding module M16a3, the core_mode extraction module M16e, the first selection module M16f, the lpd_mode extraction module M16g, the second selection module M16h, the MPS decoding module M16m, the SBR decoding module M16n, the header inspection module M28j, the header analysis module M28d, the extraction module M28b, and the selection module M28c cause the computer C10 to perform the same functions as performed by the ACELP decoding unit 16a₁, the TCX decoding unit 16a₂, the Modified AAC decoding unit 16a₃, the core_mode extraction unit 16e, the first selection unit 16f, the lpd_mode extraction unit 16g, the second selection unit 16h, the MPS decoding unit 16m, the SBR decoding unit 16n, the header inspection unit 28j, the header analysis unit 28d, the extraction unit 28b, and the selection unit 28c, respectively.

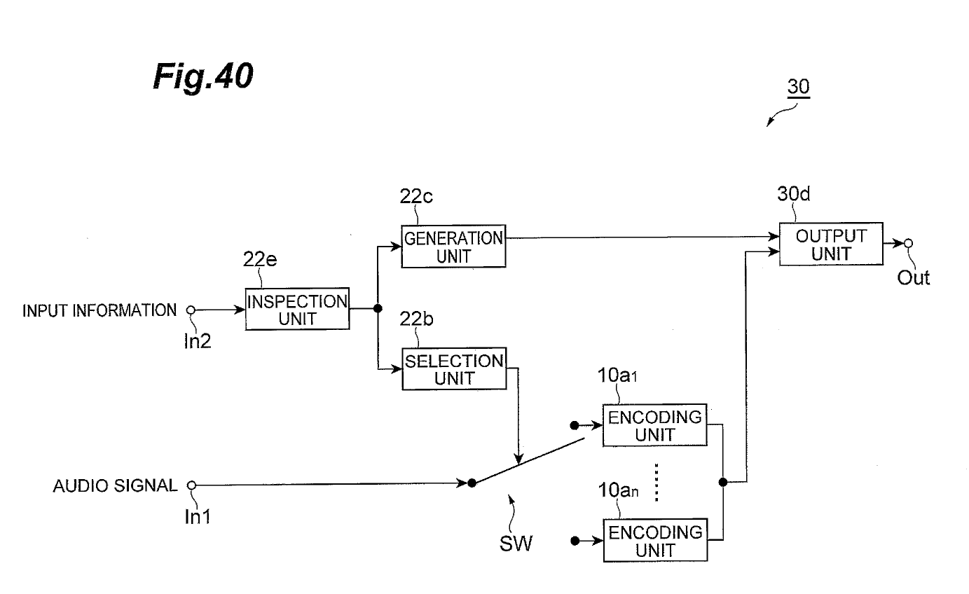

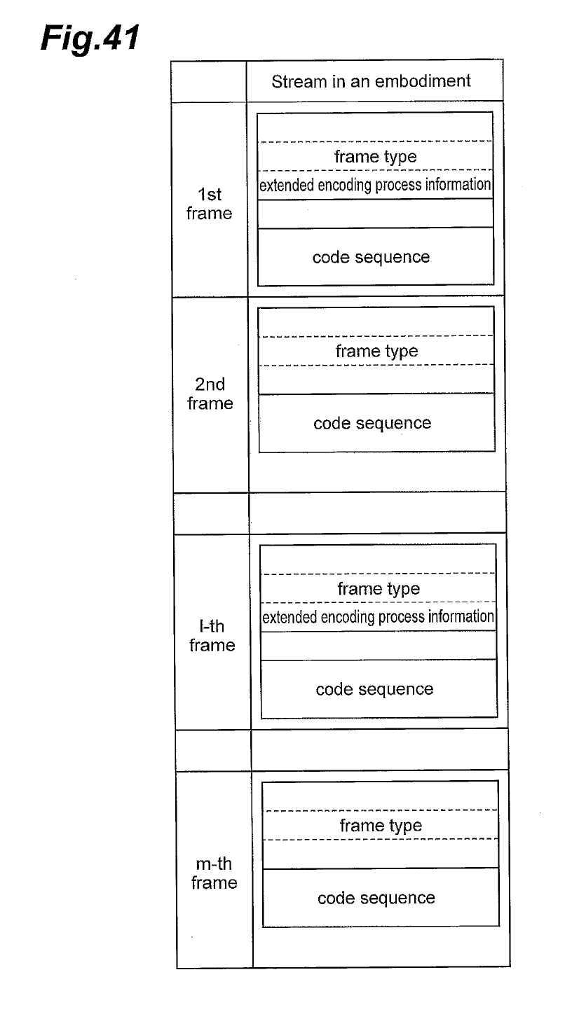

Described below is an audio encoding device according to another embodiment. FIG. 40 shows an audio encoding device according to another embodiment. FIG. 41 shows a stream generated by the audio encoding device shown in FIG. 40.

The audio encoding device 30 shown in FIG. 40 has the elements of the audio encoding device 22, except an output unit 30d. Namely, in the audio encoding device 30, when GEM_ID is generated, the output unit 30d outputs an output frame as an output frame of a first frame type including the long-term encoding scheme information. On the other hand, if the long-term encoding scheme information is not generated, the output unit 30d outputs an output frame as an output frame of a second frame type including no long-term encoding scheme information.

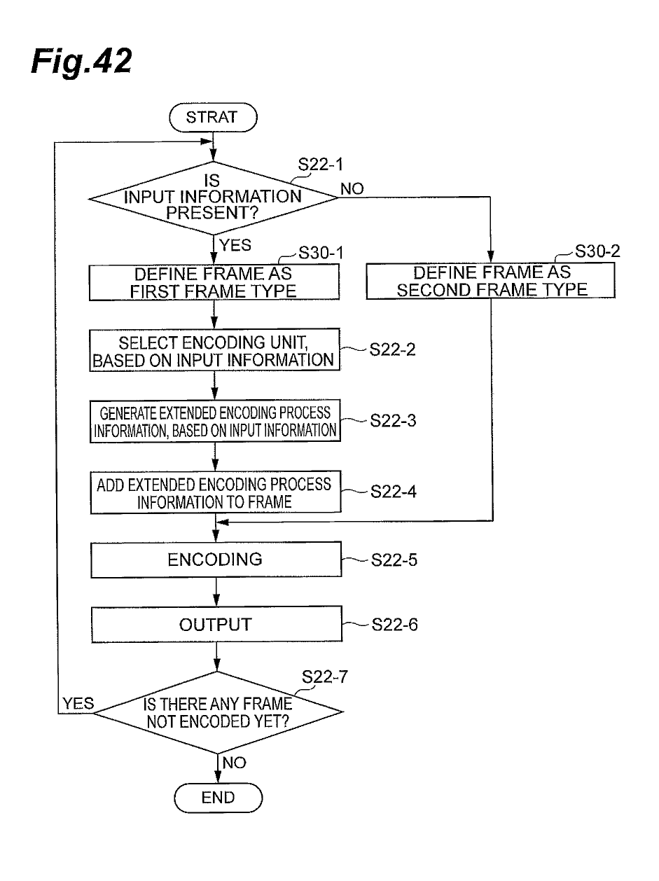

FIG. 42 is a flowchart showing an audio encoding method according to another embodiment. Described below with reference to FIG. 42 are operations of the audio encoding device 30 and the audio encoding method according to another embodiment. It is noted that the processes shown in FIG. 42 are the same as those shown in FIG. 28, except the processes of step S30-1 and step S30-2. Therefore, step S30-1 and step S30-2 will be described below.

When input information is fed in step S22-1, step S30-1 is carried out in which the output unit 30d sets an output frame corresponding to an encoding target frame found at that point to the first frame type that includes the long-term encoding scheme information. On the other hand, when no input information is fed in step S22-1, step S30-2 is carried out in which the output unit 30d sets an output frame corresponding to an encoding target frame found at that point to the second frame type including no long-term encoding scheme information. In an embodiment, the input information is inputted when the first frame of the audio signal is inputted, and an output frame corresponding to the first frame is set to the first frame type.

When the frame type is changed depending upon the presence or absence of the long-term encoding scheme information as described above, it also becomes possible to notify the decoder side of the long-term encoding scheme information.

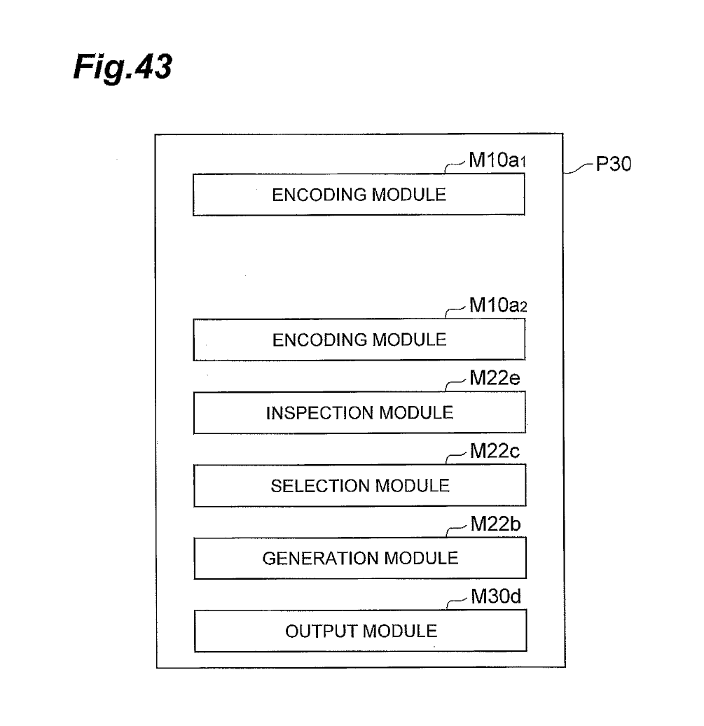

Described below is an audio encoding program that cause a computer to operate as the audio encoding device 30. FIG. 43 shows an audio encoding program according to another embodiment.

The audio encoding program P30 shown in FIG. 43 may be executed in the computer shown in FIGS. 5 and 6. Furthermore, the audio encoding program P30 can be provided in the same manner as the audio encoding program P10.

As shown in FIG. 43, the audio encoding program P30 is comprised of the encoding modules M10a₁-10aₙ, the generation module M22c, the selection module M22b, an output module M30d, and the inspection module M22e.

The encoding modules M10a₁-10aₙ, the generation module M22c, the selection module M22b, the output module M30d, and the inspection module M22e cause the computer C10 to perform the same functions as performed by the encoding units 10a₁-10aₙ, the generation unit 22c, the selection unit 22b, the output unit 30d, and the inspection unit 22e, respectively.

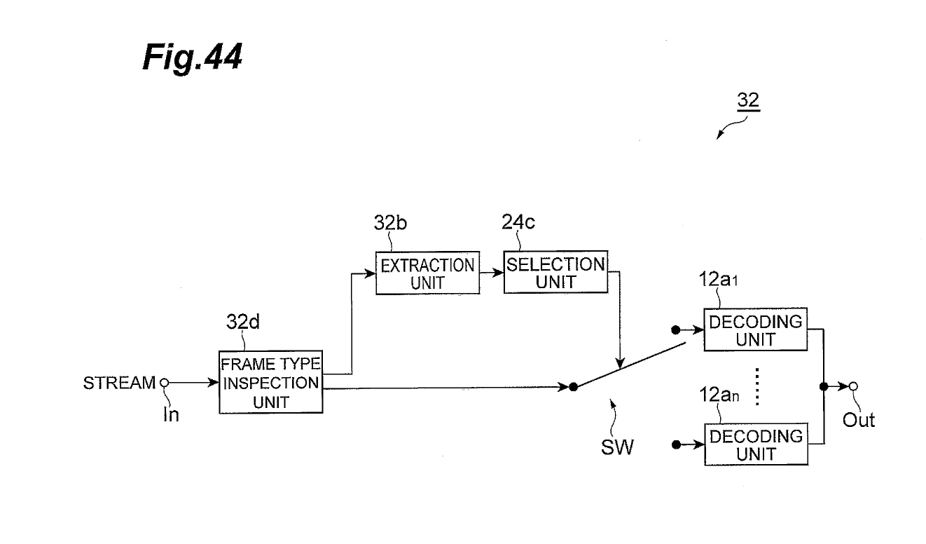

Described below is an audio decoding device that decodes a stream generated by the audio encoding device 30. FIG. 44 shows an audio decoding device according to another embodiment. The audio decoding device 32 shown in FIG. 44 has the elements in the audio decoding device 24, except an extraction unit 32b and a frame type inspection unit 32d. The extraction unit 32b and the frame type inspection unit 32d will be described below.

The frame type inspection unit 32d inspects a frame type of each frame in a stream fed to the input terminal In. Specifically, when the decoding target frame is a frame of the first frame type, the frame type inspection unit 32d provides the frame to the extraction unit 30b and the switch SW1. On the other hand, when the decoding target frame is a frame of the second frame type, the frame type inspection unit 32d sends the frame to the switch SW1 only. The extraction unit 32b extracts the long-term encoding scheme information from inside the frame received from the frame type inspection unit 32d and provides the long-term encoding scheme information to the selection unit 24c.

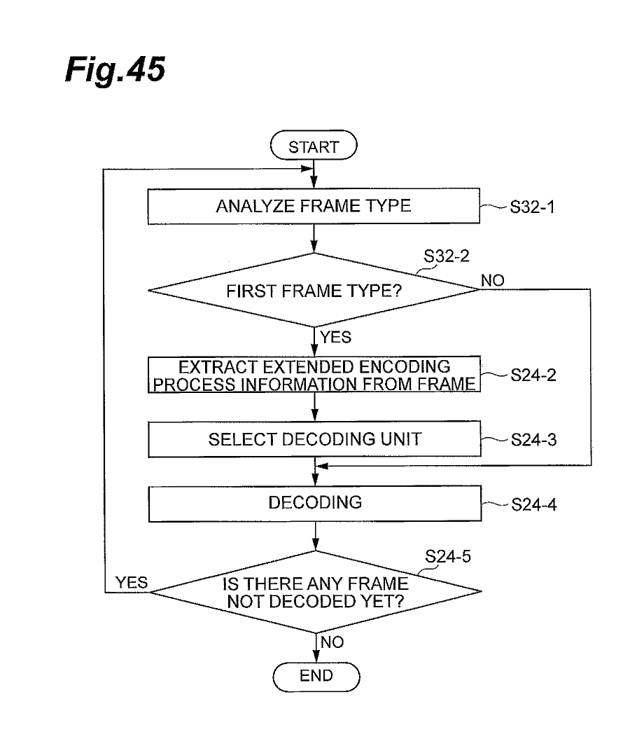

FIG. 45 is a flowchart of an audio decoding method according to another embodiment. Described below with reference to FIG. 45 are operations of the audio decoding device 32 and an audio decoding method according to another embodiment. It is noted that in the processes shown in FIG. 45, the processes represented by reference characters including “S24” are the processes shown in FIG. 31. Described below are step S32-1 and step S32-2, which are not shown in FIG. 31.

In step S32-1, the frame type inspection unit 32d analyzes whether the decoding target frame is a frame of the first frame type. When it is judged in subsequent step S32-2 that the decoding target frame is a frame of the first frame type, step S24-2 is carried out in which the extraction unit 32b extracts the long-term encoding scheme information from the frame. On the other hand, when it is determined in step S32-2 that the decoding target frame is not a frame of the first frame type, the process proceeds to step S24-4. Namely, once a decoding unit is selected in step S24-3, the common decoding unit is continuously used until a next frame of the first frame type is fed.

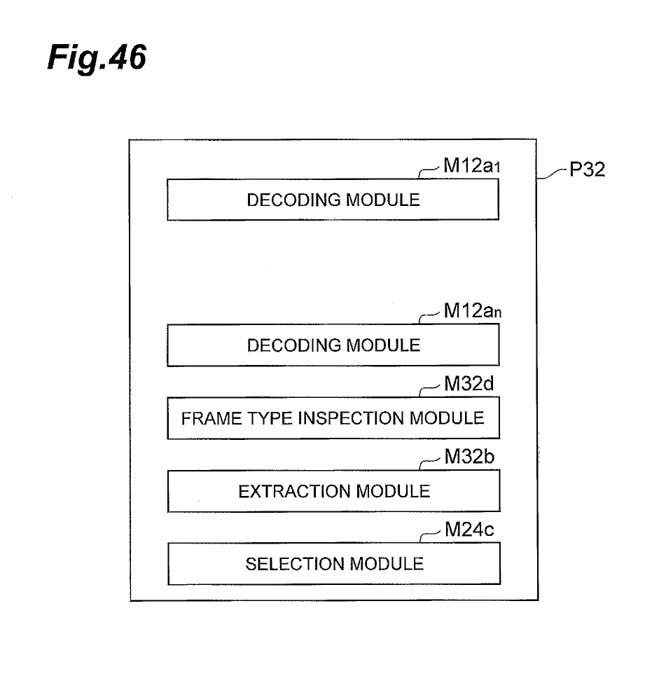

Described below is an audio decoding program that causes a computer to operate as the audio decoding device 32. FIG. 46 shows an audio decoding program according to another embodiment.

An audio decoding program P32 shown in FIG. 46 may be executed in the computer shown in FIGS. 5 and 6. Furthermore, the audio decoding program P32 can be provided in the same manner as the audio encoding program P10.

As shown in FIG. 46, the audio decoding program P24 is comprised of the decoding modules M12a₁-12aₙ, an extraction module M32b, the selection module M24c, and a frame type inspection module M32d.

The decoding modules M12a₁-12aₙ, the extraction module M32b, the selection module M24c, and the frame type inspection module M32d cause the computer C10 to perform the same functions as performed by the decoding units 12a₁-12aₙ, the extraction unit 32b, the selection unit 24c, and the frame type inspection unit 32d, respectively.

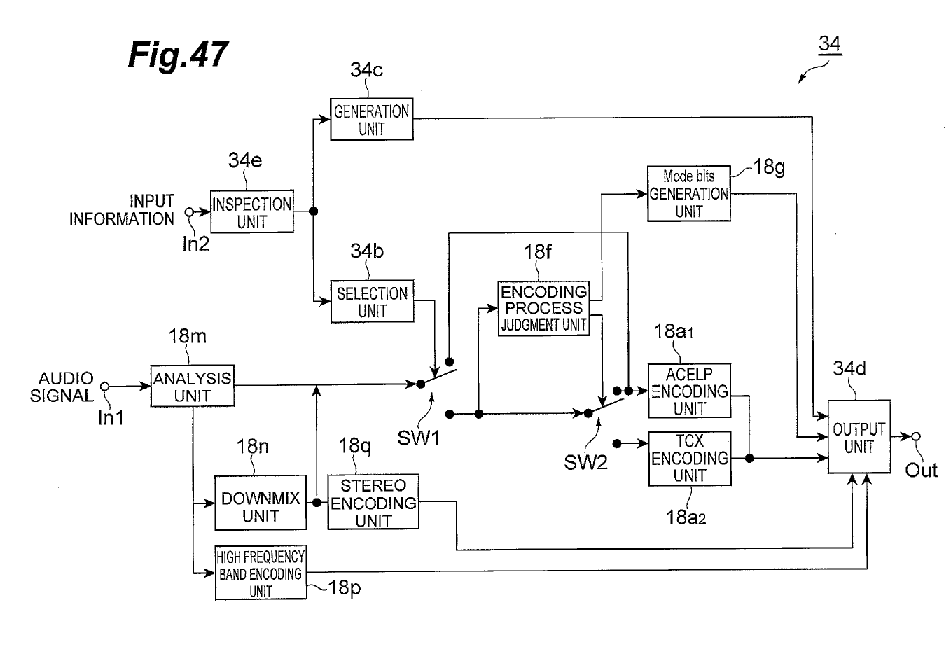

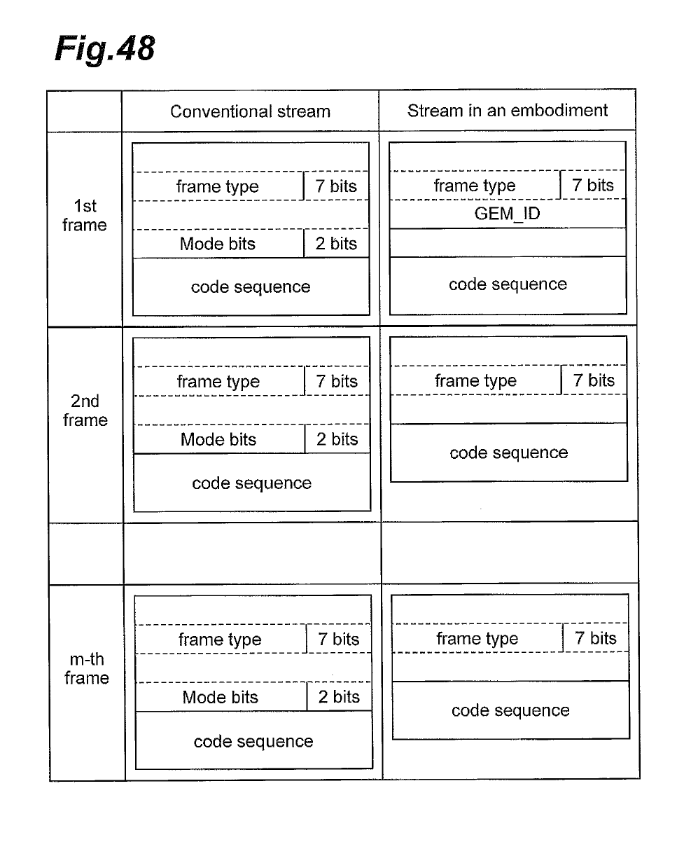

Described below is an audio encoding device according to another embodiment. FIG. 47 shows an audio encoding device according to another embodiment. The audio encoding device 34 shown in FIG. 47 is different from the audio encoding device 18 in the points described below. Namely, the audio encoding device 34 uses a common audio encoding scheme for some continuous frames of input frames and uses respective audio encoding schemes for some other frames. The audio encoding device 34 uses a common audio encoding scheme for first plurality of frames, uses respective audio encoding schemes for some subsequent frames, and uses a common audio encoding scheme for second plurality of frames subsequent thereto. FIG. 48 shows a stream generated according to conventional AMR-WB+ and a stream generated by the audio encoding device shown in FIG. 47. As shown in FIG. 48, the audio encoding device 34 outputs frames of the first frame type including GEM_ID and frames of the second frame type not including GEM_ID.

As shown in FIG. 47, like the audio encoding device 18, the audio encoding device 34 is comprised of the ACELP encoding unit 18a₁, the TCX encoding unit 18a₂, the encoding scheme judgment unit 18f, the Mode bits generation unit 18g, the analysis unit 18m, the downmix unit 18n, the high frequency band encoding unit 18p, and the stereo encoding unit 18q. The audio encoding device 34 is further comprised of an inspection unit 34e, a selection unit 34b, a generation unit 34c, and an output unit 34d. Described below are elements among the elements of the audio encoding device 34 which are different from those of the audio encoding device 18.

The inspection unit 34e monitors an input of input information to the input terminal In2. The input information indicates whether a common encoding scheme is to be used for audio signals of multiple frames. When the inspection unit detects an input of the input information, the selection unit 34b determines whether the input information indicates that a common encoding scheme is to be used for audio signals of multiple frames. When the input information indicates that a common encoding scheme is to be used for audio signals of multiple frames, the selection unit 34b controls the switch SW1 to connect the switch SW1 to the ACELP encoding unit 18a₁. This connection is maintained until an input of next input information is detected. On the other hand, when the input information does not indicate that a common encoding scheme is to be used for audio signals of multiple frames, i.e., when the input information indicates that respective encoding schemes are to be used for respective encoding target frames, the selection unit 34b connects the switch SW1 to a path including the encoding scheme judgment unit 18f and others.

When the inspection unit detects an input of the input information, the generation unit 34c generates GEM_ID having a value according to the input information. Specifically, when the input information indicates that a common encoding scheme is to be used for audio signals of multiple frames, the generation unit 34c sets the value of GEM_ID to “1.” On the other hand, when the input information does not indicate that a common encoding scheme is to be used for audio signals of multiple frames, the generation unit 34c sets the value of GEM_ID to “0.”

When the inspection unit 34e detects the input information, the output unit 34d adopts an output frame corresponding to an encoding target frame found at that point as an output frame of the first frame type, adds GEM_ID generated by the generation unit 34c in the output frame, and adds a coded sequence of an audio signal of the encoding target frame in the output frame. When the value of GEM_ID is 0, the output unit 34d adds Mode bits[k] in the output frame. On the other hand, when the inspection unit 34e detects no input information, the output unit adopts an output frame corresponding to the encoding target frame found at that point as an output frame of the second frame type and adds a coded sequence of an audio signal of the encoding target frame in the output frame. The output unit 34d outputs the output frame generated as described above.

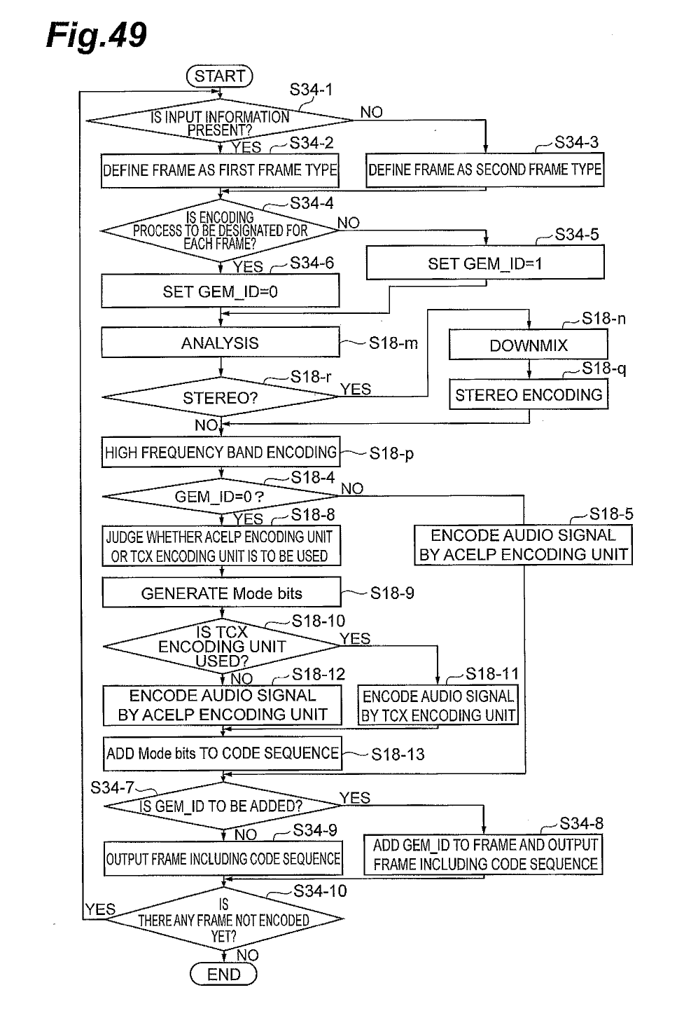

FIG. 49 is a flowchart of an audio encoding method according to another embodiment. Described below with respect to FIG. 49 are operations of the audio encoding device 34 and the audio encoding method according to 1 another embodiment. It is noted that in the processes shown in FIG. 49, the processes represented by reference characters including “S18” are the processes shown in FIG. 21. Described below are the processes among the processes in the flow shown in FIG. 49 which are different from those in FIG. 21.

In the embodiment as shown in FIG. 49, in step S34-1, the inspection unit 34e monitors an input of input information to the input terminal In2. When an input of input information is detected, subsequent step S34-2 is carried out in which an output frame corresponding to the encoding target frame is adopted as an output frame of the first frame type. On the other hand, when an input of input information is not detected, subsequent step S34-3 is carried out in which an output frame corresponding to the encoding target frame is adopted as an output frame of the second frame type.

It is then judged in step S34-4 whether the input information indicates that encoding schemes are designated for respective frames. Namely, it is judged whether the input information indicates that a common encoding scheme is to be used for multiple frames. When the input information indicates that a common encoding scheme is to be used for multiple frames, subsequent step S34-5 is carried out in which the value of GEM_ID is set to “1.” On the other hand, when the input information does not indicate that a common encoding scheme is to be used for multiple frames, subsequent step S34-6 is carried out in which the value of GEM_ID is set to “0.”

It is judged in step S34-7 whether GEM_ID is to be added. Specifically, if the encoding target frame being processed is the one found when an input of input information is detected, subsequent step S34-8 is carried out in which GEM_ID is added and an output frame of the first frame type including a coded sequence is outputted. On the other hand, if the encoding target frame being processed is one found when an input of input information is detected, subsequent step S34-9 is carried out in which an output frame of the second frame type including a coded sequence is outputted.

It is then judged in step S34-10 whether there is any frame left to be encoded. When there is no frame left uncoded, the process ends. On the other hand, when there is a frame left to be encoded, the processes from step S34-1 are executed for a target frame.

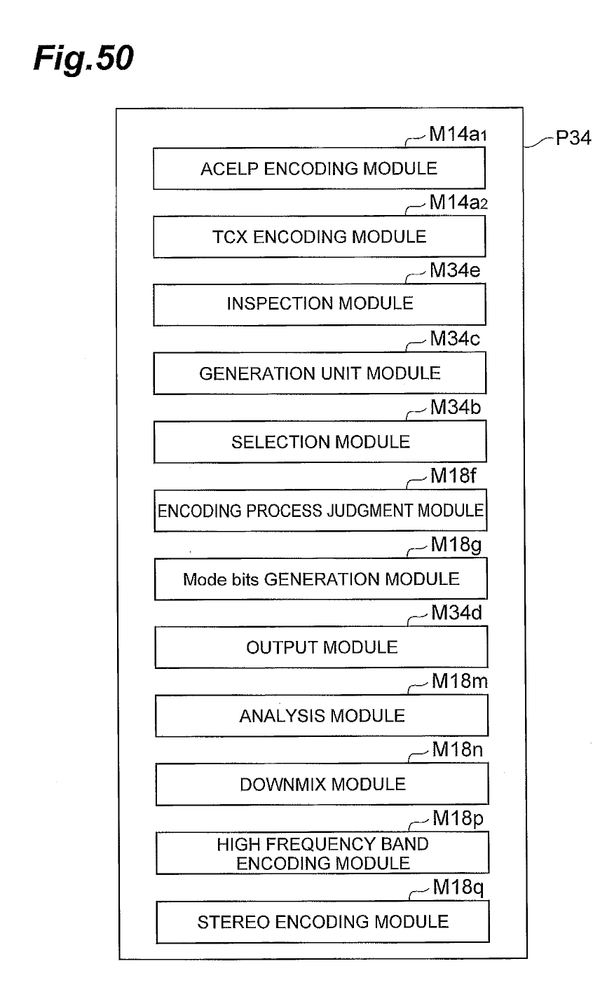

Describe below is an audio encoding program that cause a computer to operate as the audio encoding device 34. FIG. 50 shows an audio encoding program according to another embodiment.

The audio encoding program P34 shown in FIG. 50 may be executed in the computer shown in FIGS. 5 and 6. Furthermore, the audio encoding program P34 can be provided in the same manner as the audio encoding program P10.

An audio encoding program P34 is comprised of the ACELP encoding module M18a₁, the TCX encoding module M18a₂, a selection module M34b, a generation module M34c, an output module M34d, the encoding scheme judgment module M18f, the Mode bits generation module M18g, the analysis module M18m, the downmix module M18n, the high frequency band encoding module M18p, and the stereo encoding module M18q.

The CELP encoding module M18a₁, the TCX encoding module M18a₂, the selection module M34b, the generation module M34c, the output module M34d, the encoding scheme judgment module M18f, the Mode bits generation module M18g, the analysis module M18m, the downmix module M18n, the high frequency band encoding module M18p, and the stereo encoding module M18q cause the computer C10 to perform the same functions as performed by the ACELP encoding unit 18a₁, the TCX encoding unit 18a₂, the selection unit 34b, the generation unit 34c, the output unit 34d, the encoding scheme judgment unit 18f, the Mode bits generation unit 18g, the analysis unit 18m, the downmix unit 18n, the high frequency band encoding unit 18p, and the stereo encoding unit 18q, respectively.

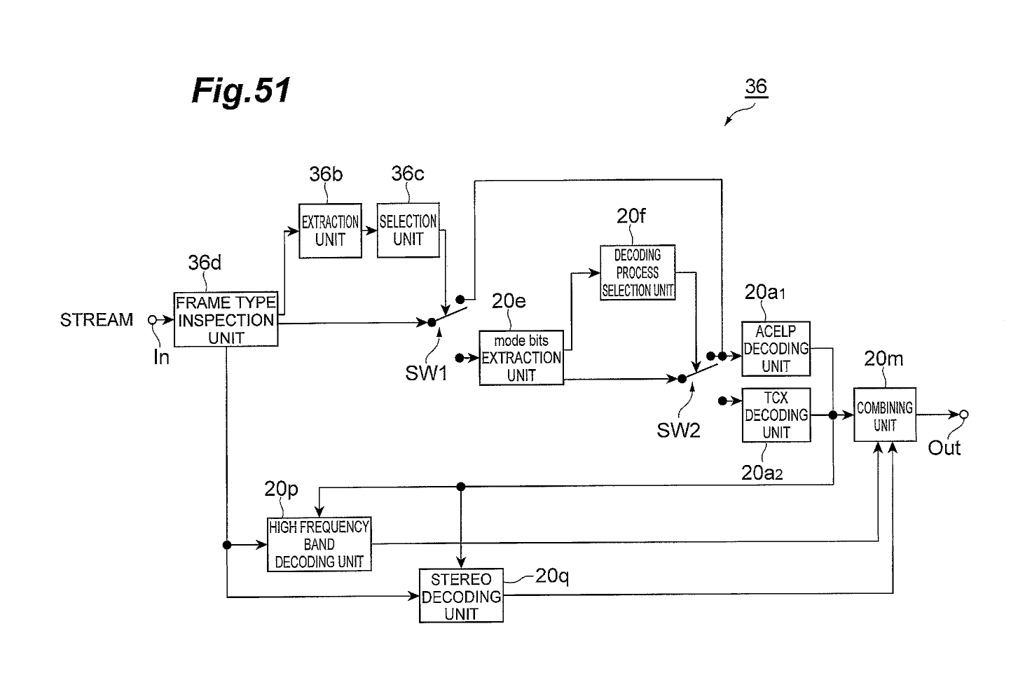

Described below is an audio decoding device that decodes a stream generated by the audio encoding device 34. FIG. 51 shows an audio decoding device according to another embodiment.

Like the audio decoding device 20, an audio decoding device 36 shown in FIG. 51 is comprised of the ACELP decoding unit 20a₁, the TCX decoding unit 20a₂, the Mode bits extraction unit 20e, the decoding scheme selection unit 20f, the high frequency band decoding unit 20p, the stereo decoding unit 20q, and the synthesis unit 20m. The audio decoding device 36 is further comprised of a frame type inspection unit 36d, an extraction unit 36b, and a selection unit 36c. Described below are elements among the elements of the audio decoding device 36 which are different from those of the audio decoding device 20.

The frame type inspection unit 36d inspects a frame type of each frame in a stream fed to the input terminal In. The frame type inspection unit 36d sends a frame of the first frame type to the extraction unit 36b, the switch SW1, the high frequency band decoding unit 20p, and the stereo decoding unit 20q. On the other hand, the frame type inspection unit 36d sends a frame of the second frame type to the switch SW1, the high frequency band decoding unit 20p, and the stereo decoding unit 20q only.

The extraction unit 36b extracts GEM_ID from the frame received from the frame type inspection unit 36d. The selection unit 36c controls the switch SW1 according to the value of GEM_ID extracted. Specifically, when the value of GEM_ID is “1,” the selection unit 36c controls the switch SW1 to connect the decoding target frame to the ACELP decoding unit 20a₁. When the value of GEM_ID is “1,” the ACELP decoding unit 20a₁ is continuously selected until a next frame of the first frame type is fed. On the other hand, when the value of GEM_ID is “0,” the selection unit 36c controls the switch SW1 to connect the decoding target frame to the Mode bits extraction unit 20e.

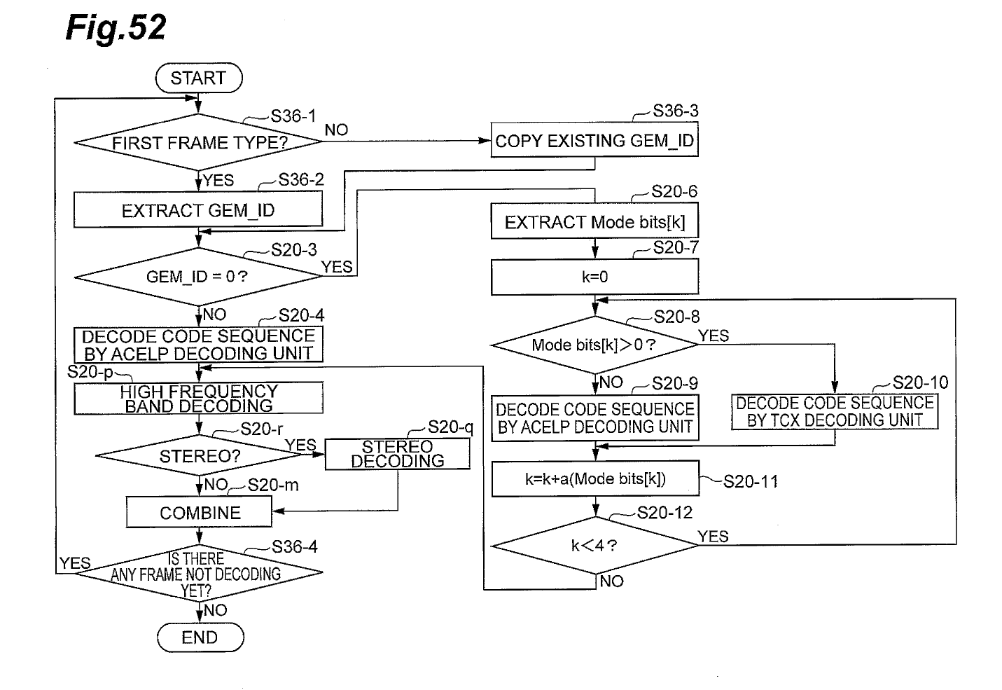

FIG. 52 is a flowchart of an audio decoding method according to another embodiment. Described below with reference to FIG. 52 are operations of the audio decoding device 36 and the audio decoding method according to another embodiment. It is noted that in the processes shown in FIG. 52, the processes including “S20” are the processes shown in FIG. 24. Described below are the processes among the processes in the flow shown in FIG. 52 which are different from those shown in FIG. 24.

In the embodiment as shown in FIG. 52, in step S36-1, the frame type inspection unit 36d judges whether the decoding target frame is a frame of the first frame type. When the decoding target frame is a frame of the first frame type, subsequent step S36-2 is carried out in which the extraction unit 36b extracts GEM_ID. On the other hand, when the decoding target frame is a frame of the second frame type, subsequent step S36-3 is carried out in which existing GEM_ID is copied and used in the subsequent processes.

It is judged in step S36-4 whether there is any frame left to be decoded. When there is no frame left to be decoded, the process ends. On the other hand, there is a frame left to be decoded, the processes from step S36-1 are executed for a target frame.

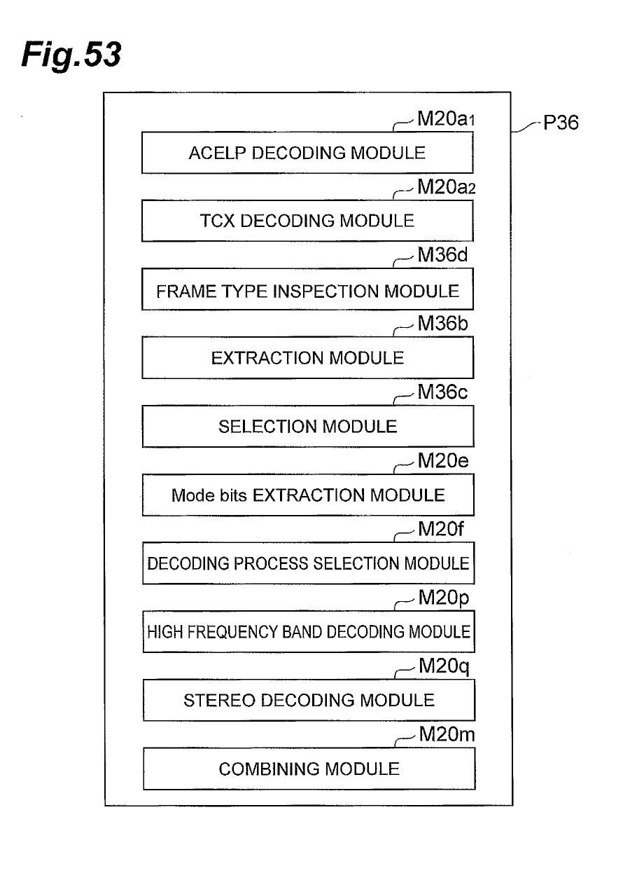

Described below is an audio decoding program that causes a computer to operate as the audio decoding device 36. FIG. 53 shows an audio decoding program according to another embodiment.

The audio decoding program P36 shown in FIG. 53 may be executed in the computer shown in FIGS. 5 and 6. The audio decoding program P36 can be provided in the same manner as the audio encoding program P10.

The audio decoding program P36 is comprised of the ACELP decoding module M20a₁, the TCX decoding module M20a₂, an extraction module M36b, a selection module M36c, a frame type inspection module M36d, the Mode bits extraction module M20e, the decoding scheme selection module M20f, the high frequency band decoding module M20p, the stereo decoding module M20q, and the synthesis module M20m.

The ACELP decoding module M20a₁, the TCX decoding module M20a₂, the extraction module M36b, the selection module M36c, the frame type inspection module M36d, the Mode bits extraction module M20e, the decoding scheme selection module M20f, the high frequency band decoding module M20p, the stereo decoding module M20q, and the synthesis module M20m cause a computer to perform the same functions as performed by the ACELP decoding unit 20a₁, the TCX decoding unit 20a₂, the extraction unit 36b, the selection unit 36c, the frame type inspection unit 36d, the Mode bits extraction unit 20e, the decoding scheme selection unit 20f, the high frequency band decoding unit 20p, the stereo decoding unit 20q, and the synthesis unit 20m, respectively.

The various embodiments of the present invention have been described above. It should be noted that the present invention is not limited to the above-described embodiments and may be modified in many ways. For example, in some of the above-described embodiments, the ACELP encoding scheme and the ACELP decoding scheme are selected as an encoding scheme and a decoding scheme used commonly for multiple frames. However, the encoding scheme and decoding scheme used commonly are not always limited to the ACELP encoding scheme and decoding scheme. They may be any audio encoding scheme and audio decoding scheme. Furthermore, aforementioned GEM_ID may be GEM_ID set in any bit size and value.

What is claimed is:

1. An audio decoding device comprising;
a plurality of decoding units which execute different audio decoding schemes, respectively, to generate audio signals from coded sequences;
an extraction unit which extracts, from a stream having multiple frames each including a coded sequence of an audio signal and/or multiple super-frames each including a plurality of frames, a unit of long-term encoding scheme information for the multiple frames which indicates that a common audio encoding scheme is to be used to generate coded sequences of the multiple frames, or a unit of long-term encoding scheme information for the multiple super-frames which indicates that a set of common audio encoding schemes is to be used to generate coded sequences of the multiple super-frames; and
a selection unit which, in response to extraction of the long-term encoding scheme information, selects, from the plurality of decoding units, a decoding unit to be used commonly to decode the coded sequences of the multiple frames, or selects, from the plurality of decoding units, a set of decoding units to be used commonly to decode the coded sequences of the multiple super-frames.

2. The audio decoding device according to claim 1, wherein in the stream, each frame coming subsequent to a lead frame in the multiple frames does not include information for specifying an audio encoding scheme to be used to generate a coded sequence of said each frame.

3. The audio decoding device according to claim 2, wherein the selection unit selects a predetermined decoding unit from the plurality of decoding units according to the long-term encoding scheme information extracted by the extraction unit, and
wherein the stream does not include information for specifying an audio encoding scheme used to generate the coded sequences of the multiple frames.

4. The audio decoding device according to claim 3, wherein the long-term encoding scheme information is 1-bit information.

5. An audio encoding device comprising:
a plurality of encoding units which execute different audio encoding schemes, respectively, to generate coded sequences from audio signals;
a selection unit which selects, the plurality of encoding units, an encoding unit to be used commonly to encode audio signals of multiple frames or selects, from the plurality of encoding units, a set of encoding units to be used commonly to encode audio signals of multiple super-frames each including a plurality of frames;
a generation unit which generates a unit of long-term encoding scheme information for the multiple frames which indicates that a common audio encoding scheme is to be used to generate coded sequences of the multiple frames, or a unit of long-term encoding scheme information for the multiple super-frames which indicates that a set of common audio encoding schemes is to be used to generate coded sequences of the multiple super-frames; and
an output unit which outputs a stream including the coded sequences of the multiple frames generated by the encoding unit selected by the selection unit, or the coded sequences of the multiple super-frames generated by the set of encoding units selected by the selection unit, and the long-term encoding scheme information.

6. The audio encoding device according to claim 5, wherein in the stream, each frame subsequent to a lead frame in the multiple frames does not include information for specifying an audio encoding scheme to be used to generate a coded sequence of said each frame.

7. The audio encoding device according to claim 6, wherein the selection unit selects a predetermined encoding unit from the plurality of encoding units, and
wherein the stream does not include information for specifying an audio encoding scheme to be used to generate the coded sequences of the multiple frames.

8. The audio encoding device according to claim 7, wherein the long-term encoding scheme information is 1-bit information.

9. An audio decoding method comprising;
a step of extracting, from a stream having multiple frames each including a coded sequence of an audio signal and/or multiple super-frames each including a plurality of frames, a unit of long-term encoding scheme information for the multiple frames which indicates that a common audio encoding scheme is to be used to generate coded sequences of the multiple frames, or a unit of long-term encoding scheme information for the multiple super-frames which indicates a set of common audio encoding schemes is to be used to generate coded sequences of the multiple super-frames;
a step of, in response to extraction of the long-term encoding scheme information, selecting, from a plurality of different audio decoding schemes, an audio decoding scheme to be used commonly to decode the coded sequences of the multiple frames, or selecting, from the plurality of audio decoding schemes, a set of audio decoding schemes to be used commonly to decode the coded sequences of the multiple super-frames; and
a step of decoding the coded sequences of the multiple frames, using the selected audio decoding scheme, or decoding the coded sequences of the multiple super-frames, using the selected set of audio decoding schemes.

10. An audio encoding method comprising:
selecting, from a plurality of different audio decoding schemes, an audio encoding scheme to be used commonly to encode audio signals of multiple frames, or selecting, from the plurality of audio encoding schemes, a set of audio encoding schemes to be used commonly to encode audio signals of multiple super-frames each including a plurality of frames;
a step of encoding the audio signals of the multiple frames using the selected audio encoding scheme to generate coded sequences of the multiple frames, or encoding the audio signals of the multiple super-frames using the selected set of audio encoding schemes to generate coded sequences of the multiple super-frames;
a step of generating a unit of long-term encoding scheme information for the multiple frames which indicates that a common audio encoding scheme is to be used to generate the coded sequences of the multiple frames, or a unit of long-term encoding scheme information for the multiple super-frames which indicates that a set of common audio encoding schemes is to be used to generate the coded sequences of the multiple super-frames; and
a step of outputting a stream including the coded sequences of the multiple frames or the coded sequences of the multiple super-frames, and the long-term encoding scheme information.

11. A non-transitory storage medium that includes a program for causing a computer to function as:
a plurality of decoding units which execute different audio decoding schemes, respectively, to generate audio signals from coded sequences;
an extraction unit which extracts, from a stream having multiple frames each including a coded sequence of an audio signal and/or multiple super-frames each including a plurality of frames, a unit of long-term encoding scheme information for the multiple frames which indicates that a common audio encoding scheme is to be used to generate coded sequences of the multiple frames, or a unit of long-term encoding scheme information for the multiple super-frames which indicates that a set of common audio encoding schemes is to be used to generate coded sequences of the multiple super-frames; and
a selection unit which, in response to extraction of the long-term encoding scheme information, selects, from the plurality of decoding units, a decoding unit to be used commonly to decode the coded sequences of the multiple frames or selects, from the plurality of decoding units, a set of decoding units to be used commonly used to decode the coded sequences of the multiple super-frames.

12. A non-transitory storage medium that includes a program for causing a computer to function as:
a plurality of encoding units which execute different audio encoding schemes, respectively, to generate coded sequences from audio signals;
a selection unit which selects, from the plurality of encoding units, an encoding unit to be used commonly to encode audio signals of multiple frames or selects, from the plurality of encoding units, a set of encoding units to be used commonly to encode audio signals of multiple super-frames each including a plurality of frames;
a generation unit which generates a unit of long-term encoding scheme information for the multiple frames which indicates that a common audio encoding scheme is to be used to generate coded sequences of the multiple frames, or a unit of long-term encoding scheme information for the multiple super-frames which indicates that a set of common audio encoding schemes is to be used to generate coded sequences of the multiple super-frames; and
an output unit which outputs a stream including the coded sequences of the multiple frames generated by the encoding unit selected by the selection unit, or the coded sequences of the multiple super-frames generated by the set of encoding units selected by the selection unit, and the long-term encoding scheme information.
